(19) United States
(12) Patent Application Publication
(10) Pub. No.: US 2023/0392853 A1
(43) Pub. Date: Dec. 7, 2023

(54) FOOD STORAGE METHOD AND APPARATUS

(71) Applicant: IRINOX S.P.A., CONEGLIANO (IT)

(72) Inventor: Florindo DA ROS, TARZO (IT)

(21) Appl. No.: 18/249,628

(22) PCT Filed: Oct. 15, 2021
(86) PCT No.: PCT/IB2021/059507

§ 371 Date: Apr. 19, 2023

(30) Foreign Application Priority Data
Oct. 20, 2020 (IT) 102020000024781

(51) Int. Cl. F25D 17/06; F25D 23/06

(52) U.S. Cl. CPC F25D 17/06; F25D 23/062; F25D 2400/28

(57) ABSTRACT

The invention relates to a method and an apparatus for preserving foods, such as fruit, vegetables, meat, fish, and the like. The foods are placed in a treatment chamber (3) and are kept in thermal exchange with an air flow cooled by a refrigerating unit. The air laps an electroscopic optimizer device (10), comprising at least one active element (20) adapted to generate an electrostatic charge because of the presence of different layers of materials (21, 22).

The present invention relates, in general, to methods and apparatuses for preserving foods.

Although in the following description reference will mostly be made to apparatuses for household use, this should not be understood as a limiting condition, and the principles of the invention may also be extended to industrial, professional or commercial applications, as will become apparent hereinafter.

As is known, preservation of foods, especially fresh ones such as fruit, meat, vegetables, and the like, is effected by storing them in cold environments, or anyway at temperatures lower than room temperature.

For cold preservation, refrigeration is typically provided within temperature intervals ranging from a few Celsius degrees above zero, e.g. 2-4° C., to values of approximately 8-10° C., depending on the foods to be preserved, preservation time (e.g. hours, weeks, etc.), outside temperature, or other possibly relevant parameters.

It is anyway known to preserve foods also at very low temperatures (below 0° C., down to about −18/−20° C.); this is done by freezing or deep-freezing the food products.

In this context, it can be stated, for simplicity, that the difference between freezing and deep-freezing lies in the time necessary for abating the food temperature, which in the deep-freezing process is shorter than in the freezing process and may range from a few minutes to one hour or slightly longer, depending on the mass to be deep-frozen.

In fact, deep-freezing rapidly transforms the water in the foods into ice, creating small crystals that will not damage the cellular structure and the fibers of the foods, so that, unlike frozen foods, when the products are brought again to room temperature or brought to cooking temperature no liquids or nutritive substances will be lost.

On the contrary, the longer duration of the freezing process leads to formation of frozen crystalline structures that are bigger (compared with deep-freezing) and that will damage the internal tissues and fibers of the foods, so that the liquids contained therein will not be retained and will percolate out when they are returned to room temperature.

Moreover, in general, deep-freezing and freezing require apparatuses having relatively high cooling power, all other parameters being equal, to keep the foods in the desired conditions; in fact, in order to obtain temperatures of frozen or deep-frozen products of approximately −18° C., the temperature of the air supplied to the evaporator needs to be −30° C. or even lower, thus requiring a non-negligible consumption of electromechanical energy by the compressor.

This applies to the whole cold chain, i.e. to all the various steps that bring frozen or deep-frozen foods from the original producer to the final consumer.

Conversely, refrigeration permits keeping the nutritional and organoleptic properties of the foods essentially unchanged, without the contraindications of the low temperatures of the freezing and deep-freezing processes.

However, this is possible only for a limited time interval.

It is commonly known, in fact, that products such as meat, fruit, vegetables, dairy products or the like can only be preserved in household refrigerators for a few days or a few weeks at most, after which they will deteriorate.

It would be desirable to be able to extend, or at least control, this preservation time.

More in general, in light of the above examination, it can be stated that the need is currently felt for improving the preservation of foods, especially as concerns temperatures above 0° C.

This would provide the advantages of cold preservation without the contraindications of the low freezing or deep-freezing temperatures.

It is therefore the object of the present invention to provide a method for preserving food and an associated device for implementing it, having such structural and functional features as to overcome the above-mentioned limitations of the prior art.

The basic idea leading to the achievement of such object is to change or anyway improve the foods' vital capability, this term indicating that capability which is brought about by some chemical-physical parameters of the substances contained therein.

In this way it is possible to affect the food preservation properties, increasing the possibility of preserving foods even at temperatures above 0° C.

The features of the invention are specifically set out in the claims appended to this description.

Such features will become more apparent in the light of the following description of an exemplary embodiment of the invention, provided herein with reference to the annexed illustrative and non-limiting drawings, wherein:

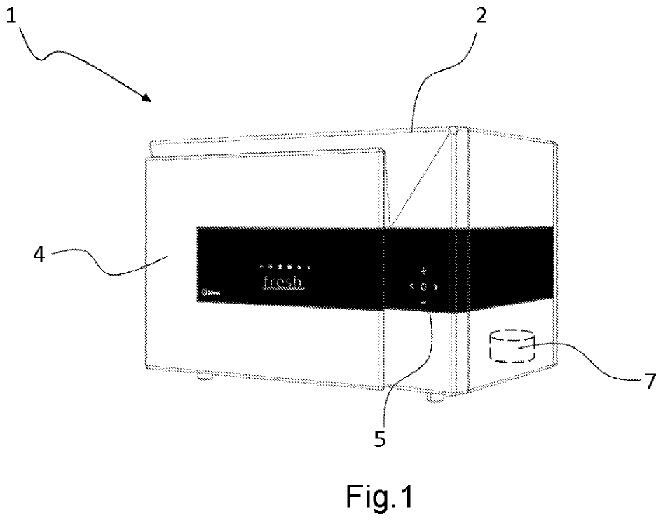

FIG. 1 shows an apparatus in accordance with the invention;

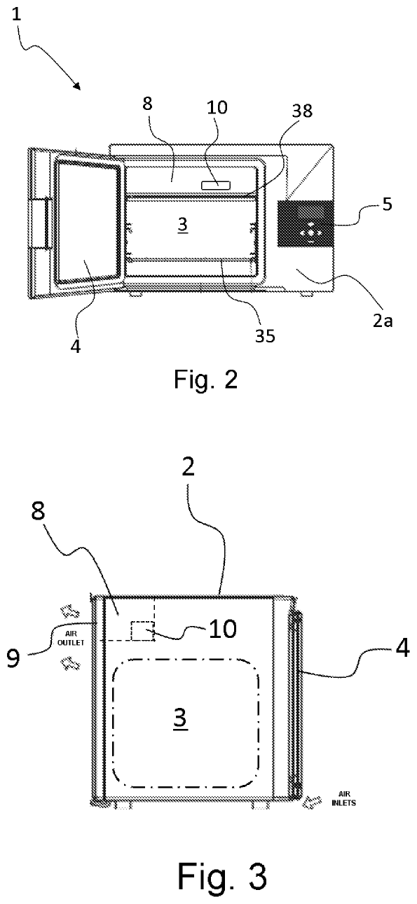

FIG. 2 shows the above apparatus in an open operating condition;

FIG. 3 is a side view of the apparatus of FIG. 2;

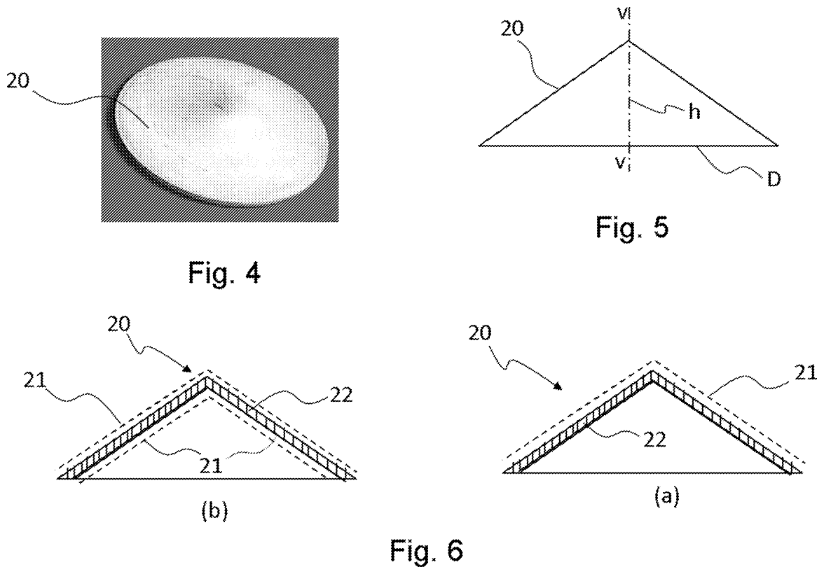

FIG. 4 is a perspective view of a conical element of a device of the apparatus according to the invention;

FIG. 5 is a front view of the element of FIG. 4;

FIGS. 6(a), 6(b) are sectional views along line VI-VI of FIG. 5 of respective embodiments of the conical element of FIG. 5;

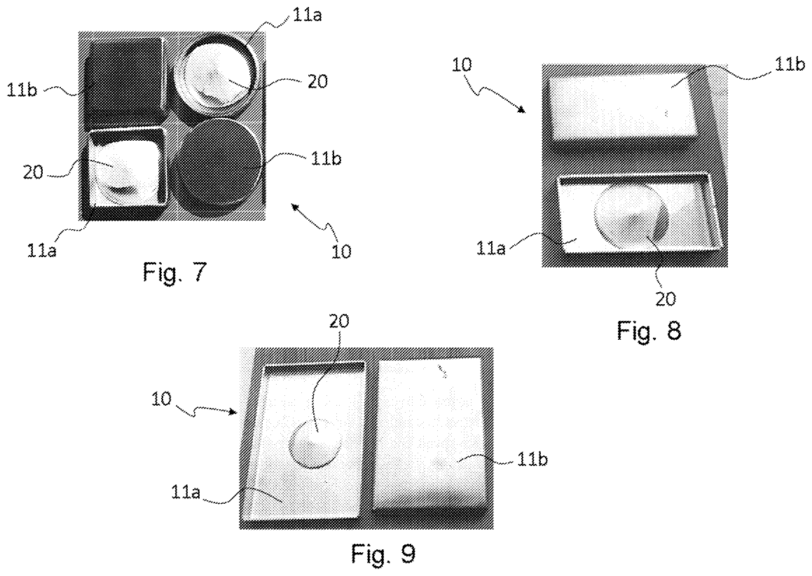

FIGS. 7, 8 and 9 show respective devices in accordance with the invention;

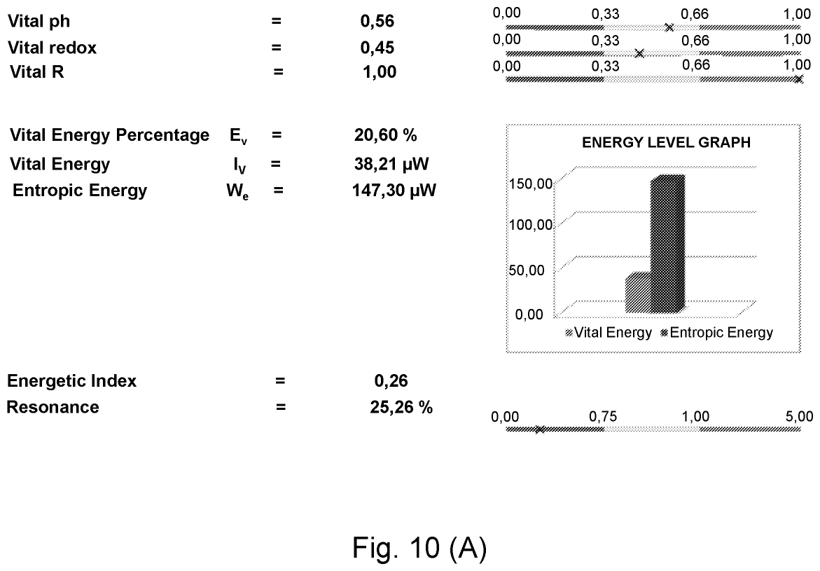

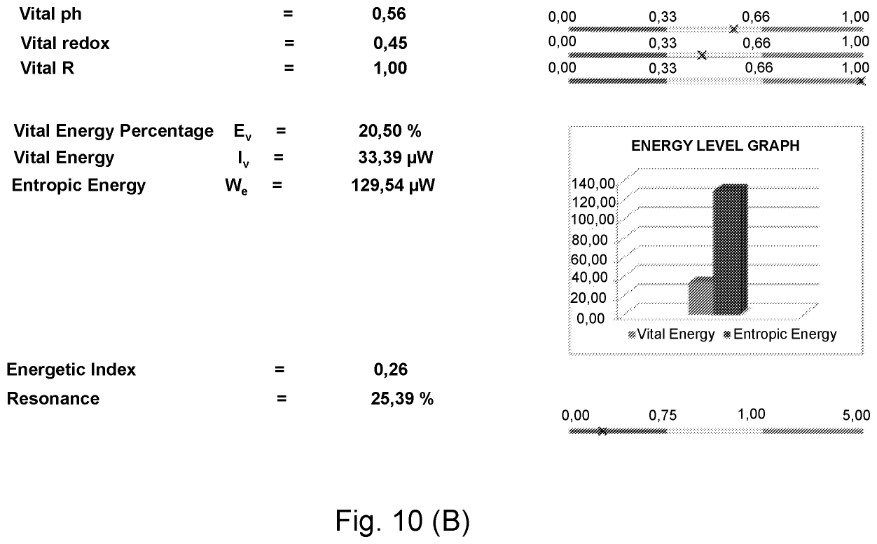

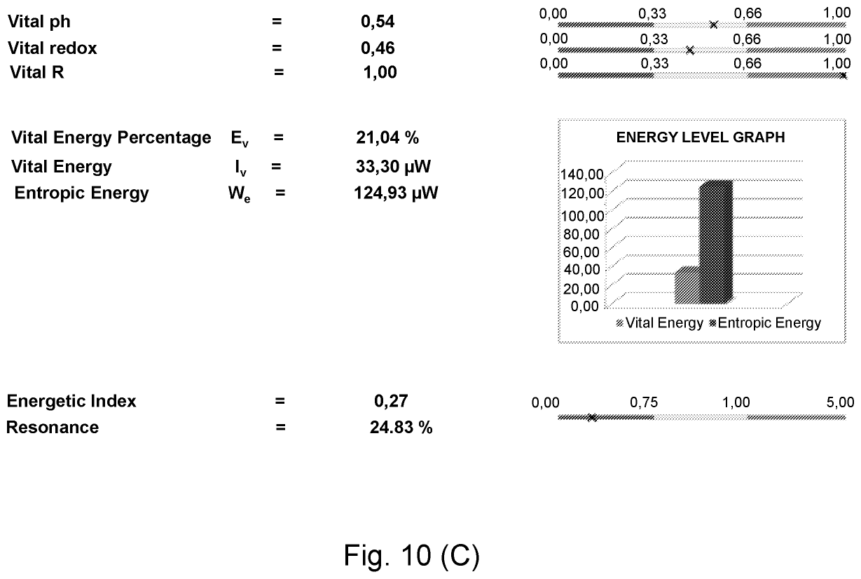

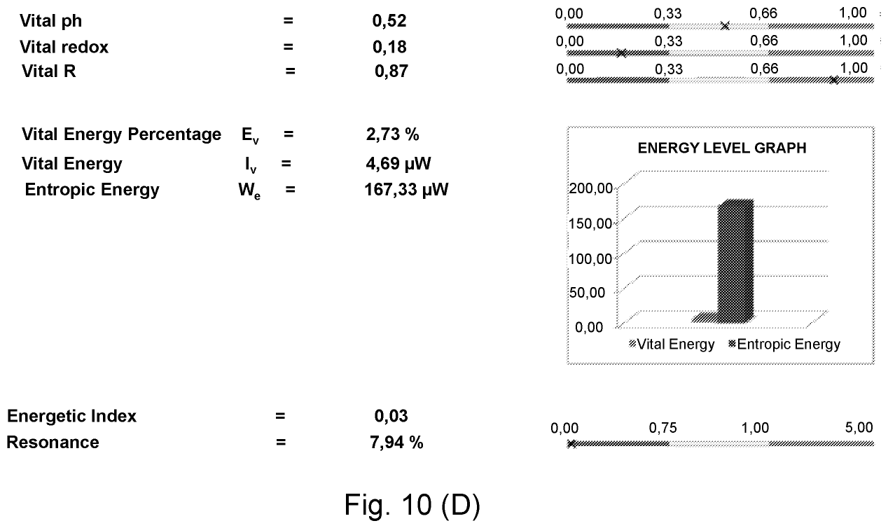

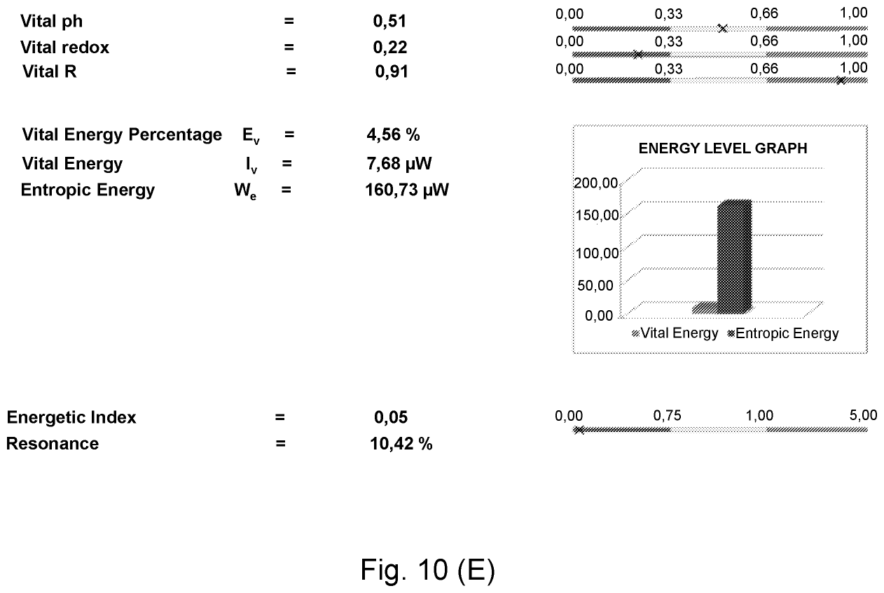

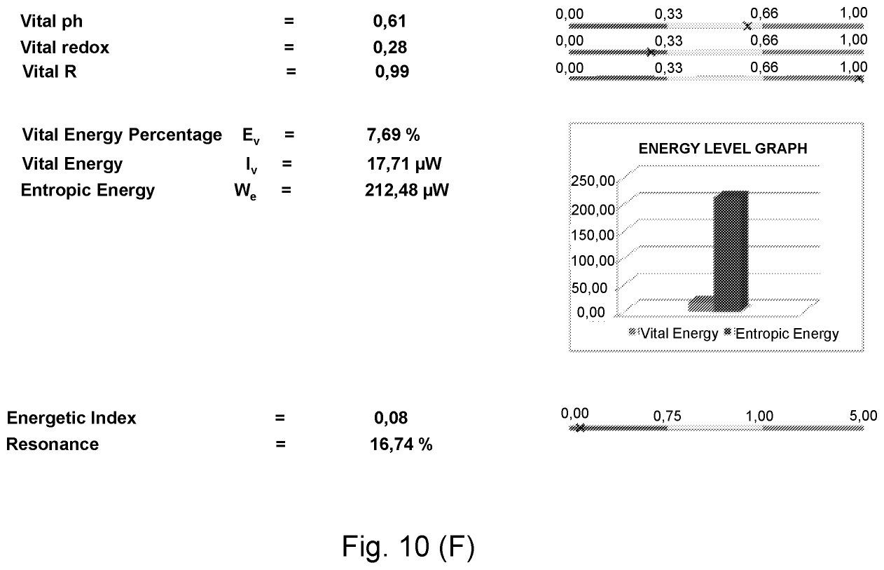

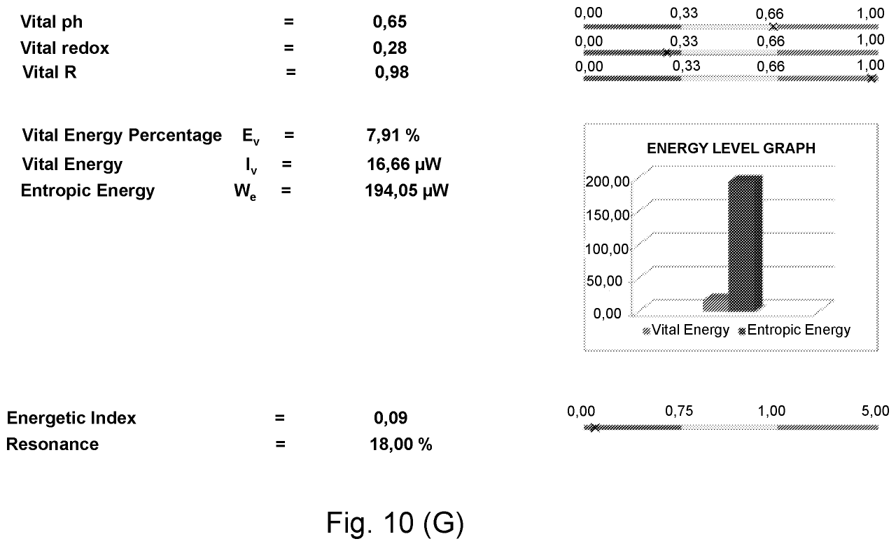

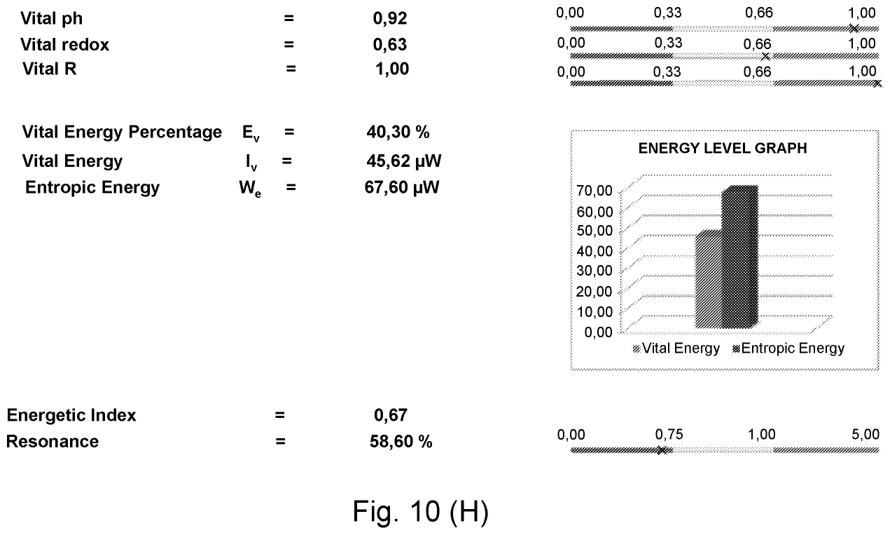

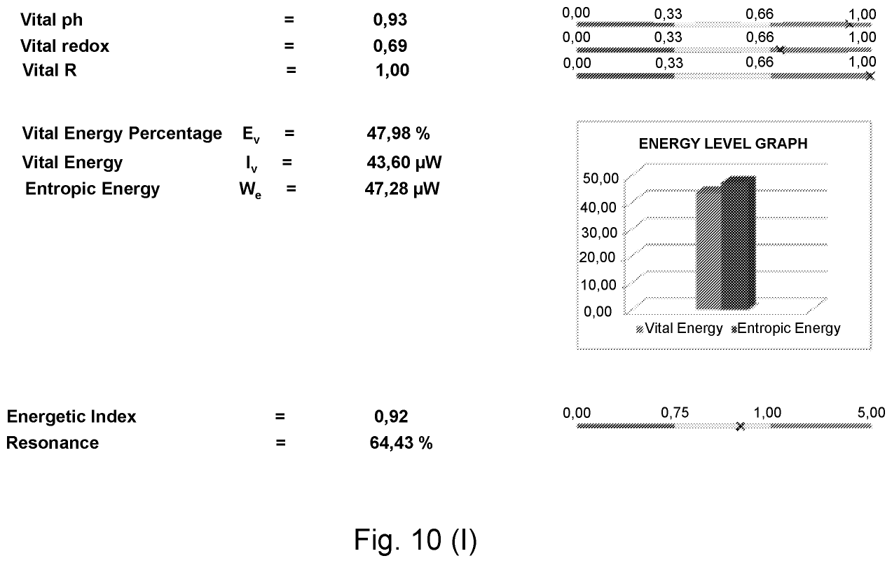

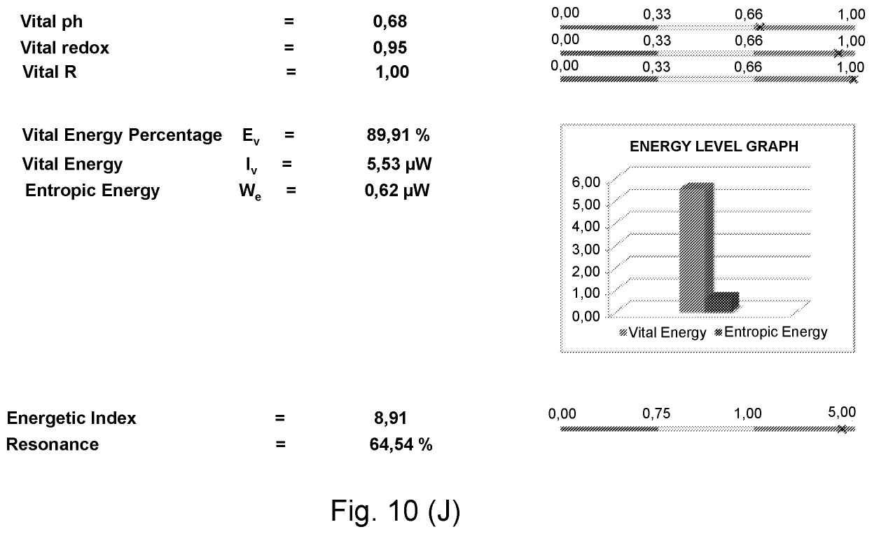

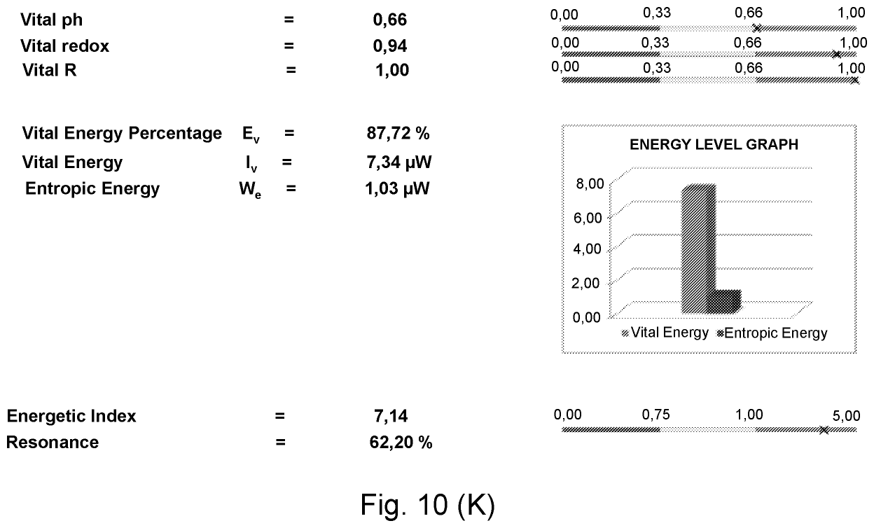

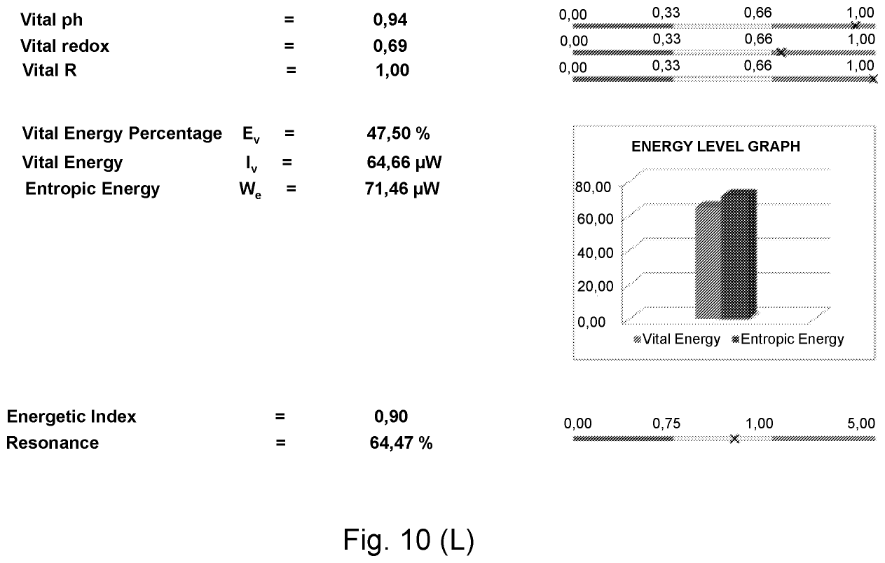

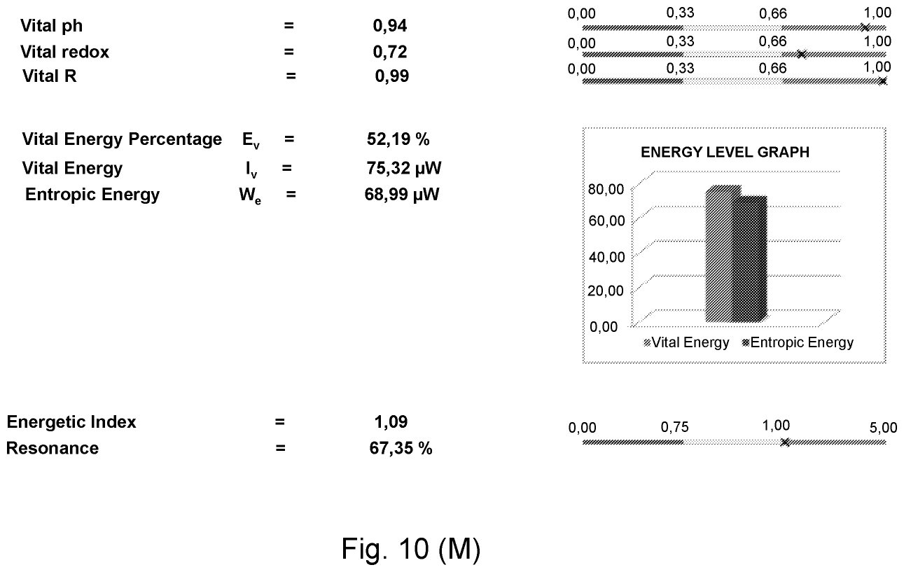

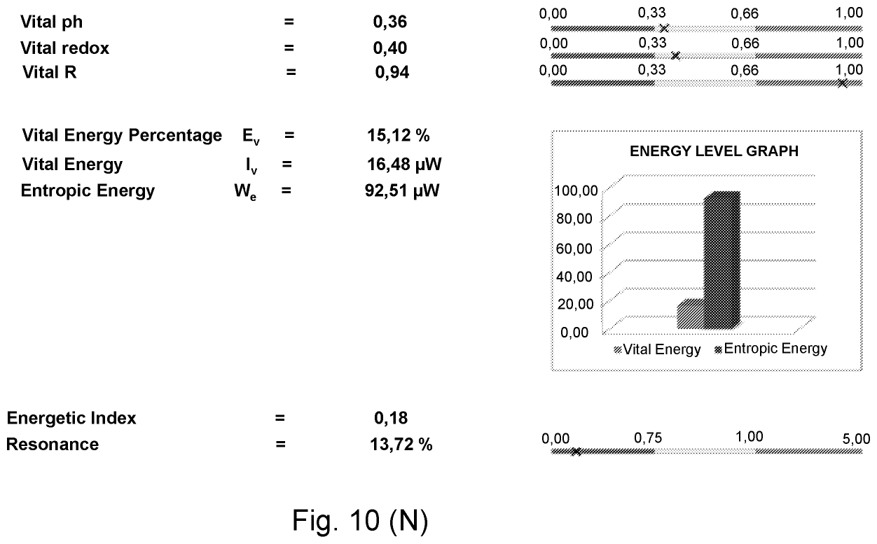

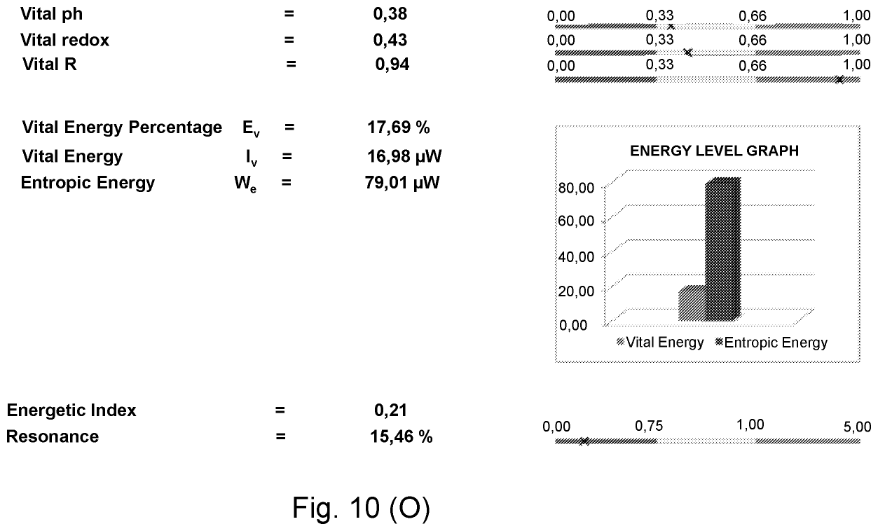

FIGS. 10A-100 show respective graphs relating to a number of variables, obtained with parameters gathered by using the above apparatus;

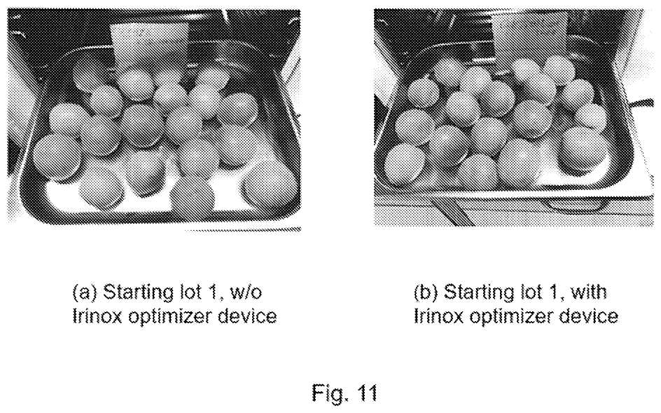

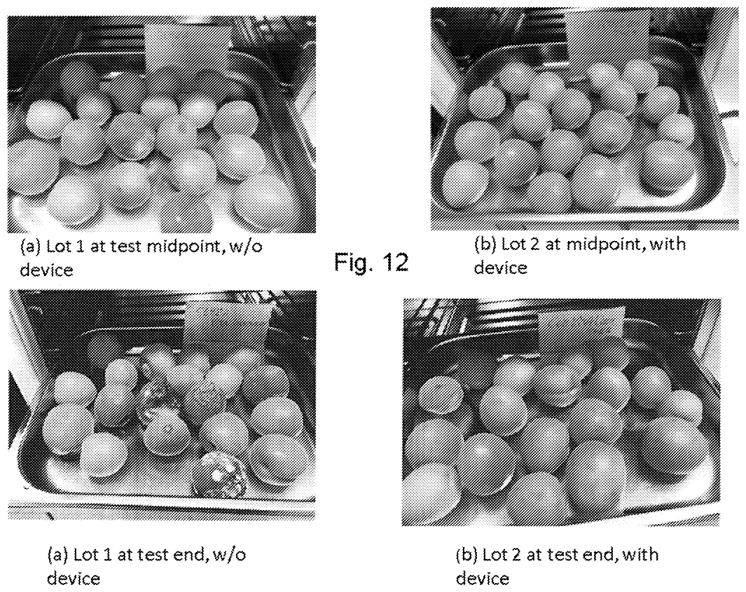

FIGS. 11 and 12 are photographs of fruit samples before and after, respectively, the treatment according to the invention;

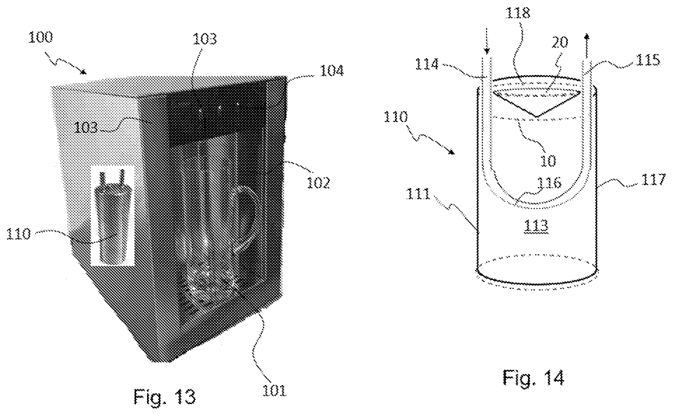

FIGS. 13 and 14 show a variant application of a device in accordance with the invention;

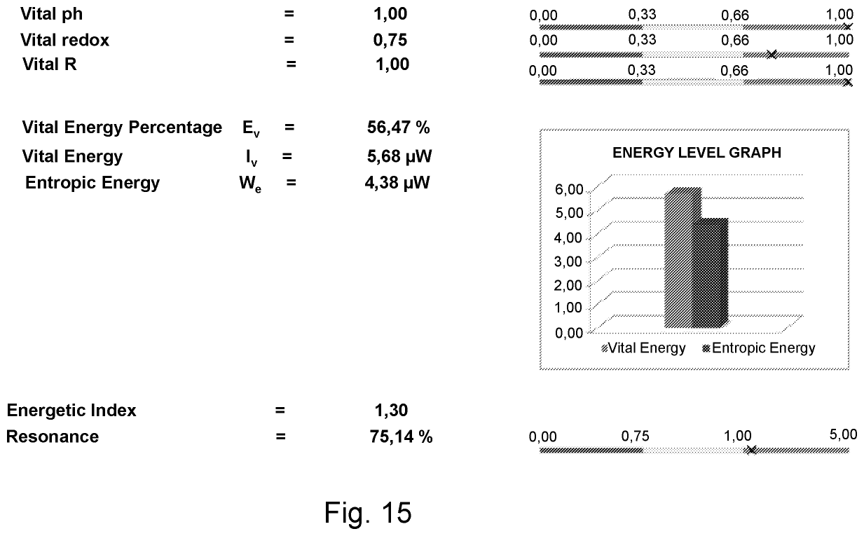

FIG. 15 shows a graph relating to some variables, obtained with parameters gathered by using the apparatus of FIGS. 13 and 14.

With reference to the above-listed figures, numeral 1 designates as a whole a food preserving machine in accordance with the invention.

Preferably, such machine is a blast chiller, i.e. a thermal apparatus (whether for household, industrial or professional use) adapted to reduce the temperature of bodies arranged therein, even by some tens of Celsius degrees, within a time ranging from several minutes to one hour, or only slightly longer.

The apparatus 1 shown in the drawings is a blast chiller named “Fresco” manufactured by the Applicant, the technical specifications of which can be freely downloaded from the Applicant's Internet site “www.irinox.com”.

Such machine has the peculiarity that, in addition to quickly cooling the products placed therein, it can also heat them and, if necessary, cook them at moderate temperatures (60-70° C.), lower than those of ovens or flame-type (i.e. gas) or electric (resistor-type or induction) cookers.

These features make the apparatus 1 also suitable for dough proofing or for any other applications requiring that food be subjected to a thermal treatment (cooling and/or heating) cycle for preserving and/or conditioning it prior to cooking or consumption.

In this context, it must be highlighted that the invention is also applicable to simple refrigeration machines, such as common refrigerators or blast chillers, which typically lack a heating function.

For brevity, since the apparatus 1 is per se known, the following will only provide the explanations necessary for understanding the invention, and reference should be made to the above-mentioned technical specifications for further details.

Therefore, the apparatus 1 comprises a parallelepiped external structure 2, within which there is a treatment chamber or cavity 3 closed at the front by a door 4; adjacent to the door 4, on the front face 2a of the structure 2, there is a touch keypad 5 acting as a user interface for controlling the operation of the apparatus 1.

The latter comprises also a refrigeration unit 6 including at least one compressor 7 and one evaporator 8, in addition to other components that are not deemed necessary for understanding the invention.

It is only worth adding that the apparatus 1 is equipped with electronic control and/or management means (not shown in the drawings for simplicity's sake), such as, for example: processors, sensors, memories, etc. powered by the mains to which the apparatus 1 is connected 1, which handle the various functions and parts of the machine in accordance with programs stored therein.

Therefore, once the user has set, by using the keypad 5, operating parameters such as a food's cooling and/or chilling time and final temperature, the machine 1 will process the necessary working cycle and then will execute it.

In this regard, it must be pointed out that blast chilling is obtained mainly by convective heat exchange, by means of a flow of air being cooled by the evaporator 8 of the refrigeration unit included in the apparatus 1 and circulating within the chamber 3.

The compressor 7 compresses the coolant of the refrigeration unit, which, flowing through the evaporator 8, cools the air flow generated by electromechanical means 9 such as fans, blowers and the like, arranged in the compartment on top of the cell.

In the treatment chamber 3 there is at least one supporting shelf 35, preferably in the form of a grill, a grid or the like, whereon the foods to be treated are laid, while in the upper part of the structure 2, on top of the chamber 3, there is a shelf 38 for supporting an optimizer device 10 in accordance with the invention.

The latter comprises a metal container or box 11, which may be cylindrical or parallelepiped in shape, or the like, internally housing at least one conical element or body 20, which is better visible in FIGS. 4-6.

The conical element 20 is made of metal material, preferably copper, whether pure or alloyed with other metals like tin, titanium, brass, aluminium, nickel, zinc, chrome, iridium, tungsten.

Therefore, the cones may be made of brass (copper-zinc), bronze (copper-tin), alloys comprising copper and aluminium (e.g. aluminium bronze) or even zinc and aluminium (zamac), as well as alloys comprising silver, gold, platinum, germanium, bismuth, or the conical elements 20 may comprise silicon, shungite, tourmaline, ceramic, various crystals, zirconium, Tesla or Kolzov plate.

The conical geometry of the body or element 20 is preferably characterized by a diameter D in the range of approximately 30 to 50 mm, preferably approximately 40 mm; the height “h” of the cone is in the range of approximately 4 mm to 15 mm, preferably 9-10 mm.

Furthermore, the conical element 20 is internally hollow, and its outer surface is coated with a silver layer 21 having a thickness of a few thousandths of a millimeter (2-4 μm);

Preferably, also the inner surface of the cone 20 is coated with a silver layer 21; the application on the outer surface of the cone 20 is shown in FIG. 6(a), while the application on both the inner and outer surfaces is visible in FIG. 6(b).

The coating 21 is preferably a sort of plating that can be applied by using any appropriate technique, e.g. chemical and/or physical material deposition, spraying, immersion painting, or the like.

Moreover, although silver has proven to be the preferred material, it is also possible to use, as the coating 21 of the conical element 20, other materials such as gold, platinum, germanium, bismuth, as well as silicon, shungite, tourmaline, ceramic, various crystals, zirconium, Tesla or Kolzov plate.

The wall 22 of the conical element 20 is also quite thin, preferably approximately 1-2 mm, so that the total weight is approximately 17 gr.

The box 11 that houses the conical element 20, or the conical elements 20 in case two or more are used, is essentially an enclosure 11a with a lid 11b, preferably made of stainless steel or other materials like copper, bronze, aluminium, zinc and titanium; thus, the box 11 containing the conical elements 20 is an essential part constituting the optimizer device 10 (also referred to as “OptiSystem”™).

The optimizer device 10, comprising the box 11 internally housing at least one conical element 20, is arranged in the blast chiller 1, preferably in a region of the path followed by the air flow circulating within the chamber 3: in this manner, the optimizer device 10 is lapped by the air and promotes contact between it and the foods.

It is believed that the optimizer device 10 placed inside the household blast chiller 1, or anyway so arranged that it is lapped by an air flow circulating in the inner chamber 3 that is formed when the apparatus is in operation, can generate a very weak electrostatic current or charge due to the presence of different metal layers (copper-silver or any one of the above-mentioned pairs of metal materials), and that such weak current or charge can, according to experience and tests carried out by the inventor, give an advantageous contribution in energetic terms, which optimizes the conditioning of the foods.

It must be pointed out that the very weak electrostatic current or charge that the optimizer device 10 can generate moves in a direction from the base to the vertex of the conical element 20. It follows that on the face of the optimizer device 10 an energizing effect is produced towards the vertex of the conical element 20. Conversely, an opposite de-energizing effect can be observed on the other face of the device 10, where the base of the conical element 20 lies. It follows that the optimizer device 10 should only be arranged in a parallel position above or under the chamber 3, not vertical on one side.

The correct orientation is with the vertex of the conical element 20 pointing upwards when positioned under the chamber, and with the vertex of the conical element 20 pointing downwards when positioned above the chamber.

Such contribution, which is conducted in the foods, is believed to promote and invigorate cellular life, thus promoting the preservation of the foods and hence the conservation of their organoleptic and nutritional properties.

A similar effect has also been observed in water samples subjected to a similar treatment.

In this context, without being bound or limited to particular physical theories or studies, it is believed that the conical shape of the optimizer element 20 can contribute to the electromagnetic interaction of the device 10 with the flow of fluid circulating in the chamber 3 and lapping the foods.

The following application examples will provide a better understanding of the above statements.

The potentialities of the blast chiller 1 provided by the Applicant were evaluated by means of comparative tests, wherein selected food samples were analyzed, before and after residence inside the blast chiller 1, switched on and ventilated, for at least 12 hours at a temperature of 24° C. (hereafter also referred to as “Opti-System™ treatment”, in order to assess the energetic modifications induced in the foods.

In particular, this comparative analysis concerned the preservation of the foods in the same conditions in a blast chiller 1 equipped with the optimizer device 10 and in one without the device 10.

Some chemical-physical parameters of the different food samples were gathered, namely: pH (acidity value); rH₂ (oxidoreduction potential); R (electrical resistivity).

The analysis of the chemical-physical parameters was conducted on samples of liquid extracted by squeezing the foods, using a measurement device called Bioelettronica ATC 330, commercially available and described in Italian patent application no. 10 2015 000013161.

In particular, all parameter analyses, irrespective of the food products subjected to the opti-system™ treatment, were conducted by heating the cell of the ATC 330 device to 37° C., in accordance with the method of operation of such device, for the purpose of simulating the typical internal temperature of the human body.

Respective tables are shown below which contain the data obtained from the different tests.

Such data were then processed by using a software program associated with the Bioelettronica ATC 330 machine, thereby generating diagrams for functions referred to as “Vital pH”; “Vital redox”; “Vital R”; “Vital energy”; “Entropic energy”; “Energetic index”; “Resonance”, as shown in the annexed figures.

### Example 1

A. Grapes—basic condition (normal environment)
B. Grapes—treatment in normal blast chiller
C. Grapes—treatment in optimized blast chiller

The following tables relate to tests carried out on a sample of juice obtained from grapes, kept in the treatment chamber 3 of a normal blast chiller 1 and of one optimized with the device 10, respectively, for approximately 12 hours at a temperature of 24° C. Only after the treatment the grapes were squeezed and immediately analyzed, to avoid the onset of sample oxidation processes.

As an additional comparison, analyses were also carried out on grapes in basic environmental conditions, i.e. not subjected to treatment in the blast chiller.

TABLE 1.A
(grapes - ambient condition)

| | | | | |
|---|---|---|---|---|
| GATHERED DATA | | | | |
| Substance: | Grape - Basic | | | |
| Date of Analysis: | 22/09/2020 | | | |
| Time of Analysis: | 10:18 | | | |
| | pH | rH₂ | R | Temp. (° C.) |
| Grape - basic | 3,954 | 22,81 | 264 | 37 |
| ANALYSIS RESULTS | | | | |
| Redox Potential | E = | 221 mV | | |
| Intensity | I = | 0,84 mA | | |
| Total energy | W = | 185,51 μW | | |

TABLE 1.B
(Grapes - treatment in normal blast chiller)

| | | | | |
|---|---|---|---|---|
| GATHERED DATA | | | | |
| Substance: | Grapes - normal blast chiller | | | |
| Date of Analysis: | 22/09/2020 | | | |
| Time of Analysis: | 10:24 | | | |
| | pH | rH₂ | R | Temp. (° C.) |
| Grapes - normal blast chiller | 3,980 | 22,86 | 301 | 37 |
| ANALYSIS RESULTS | | | | |
| Redox Potential | E = | 221 mV | | |
| Intensity | I = | 0,74 mA | | |
| Total energy | W = | 162,93 μW | | |

TABLE 1.C
(Grapes - treatment in optimized blast chiller)

| GATHERED DATA | | | | |
|---|---|---|---|---|
| Substance: | Grapes - vitalized blast chiller | | | |
| Date of Analysis: | 22/09/2020 | | | |
| Time of Analysis: | 10:31 | | | |
| | pH | rH₂ | R | Temp. (° C.) |
| Grapes - vitalized blast chiller | 3,882 | 22,56 | 304 | 37 |

ANALYSIS RESULTS

| | | |
|---|---|---|
| Redox Potential | E = | 219 mV |
| Intensity | I = | 0,72 mA |
| Total energy | W = | 158,22 μW |

### Example 2

D. Apple—treatment in normal blast chiller
E. Apple—treatment in optimized blast chiller

The following tables relate to tests carried out on samples of juice obtained from apples taken from the same lot, kept in the treatment chamber 3 of a normal blast chiller 1 and of one optimized with the device 10, respectively, for approximately 12 hours at a temperature of 24° C. Only after the treatment the apples were peeled and immediately analyzed, to avoid the onset of sample oxidation processes.

TABLE 2.D
(Apple - treatment in normal blast chiller)

| | | | | |
|---|---|---|---|---|
| GATHERED DATA | | | | |
| Substance: | Apples - normal blast chiller | | | |
| Date of Analysis: | 22/09/2020 | | | |
| Time of Analysis: | 10:49 | | | |
| | pH | rH₂ | R | Temp. (° C.) |
| Apples - normal blast chiller | 3,745 | 26,33 | 681 | 37 |
| ANALYSIS RESULTS | | | | |
| Redox Potential | E = | 342 mV | | |
| Intensity | I = | 0,50 mA | | |
| Total energy | W = | 172,02 μW | | |

TABLE 2.E
(Apple - treatment in optimized blast chiller)

| GATHERED DATA | | | | |
|---|---|---|---|---|
| Substance: | Apples - vitalized blast chiller | | | |
| Date of Analysis: | 22/09/2020 | | | |
| Time of Analysis: | 10:39 | | | |
| | pH | rH₂ | R | Temp. (° C.) |
| Apples - vitalized blast chiller | 3,722 | 25,43 | 594 | 37 |

ANALYSIS RESULTS

| | | |
|---|---|---|
| Redox Potential | E = | 316 mV |
| Intensity | I = | 0,53 mA |
| Total energy | W = | 168,41 μW |

### Example 3

F. Plum—treatment in normal blast chiller
G. Plum—treatment in optimized blast chiller

The following tables relate to tests carried out on samples of juice obtained from plums taken from the same lot, kept in the treatment chamber 3 of a normal blast chiller 1 and of one optimized with the device 10, respectively, for approximately 12 hours at a temperature of 24° C. Only after the treatment the plums were squeezed and immediately analyzed, to avoid the onset of sample oxidation processes.

TABLE 3.F
(Plum - treatment in normal blast chiller)

| GATHERED DATA | | | | |
|---|---|---|---|---|
| Substance: | Plum - normal blast chiller | | | |
| Date of Analysis: | 22/09/2020 | | | |
| Time of Analysis: | 11:00 | | | |
| | pH | rH2 | R | Temp. (° C.) |
| Plum - normal blast chiller | 4,205 | 25,47 | 364 | 37 |

ANALYSIS RESULTS

| | | |
|---|---|---|
| Redox Potential | E = | 289 mV |
| Intensity | I = | 0,80 mA |
| Total energy | W = | 230,19 μW |

TABLE 3.G
(Plum-treatment in optimized blast chiller)
GATHERED DATA

| Substance: | Plum-vitalized blast chiller |
|---|---|
| Date of Analysis: | 22 Sep. 2020 |
| Time of Analysis: | 11:03 |

| | pH | rH₂ | R | Temp. (° C.) |
|---|---|---|---|---|
| Plum-vitalized blast chiller | 4.397 | 25.84 | 392 | 37 |

ANALYSIS RESULTS

| | |
|---|---|
| Redox Potential | E = 287 mV |
| Intensity | I = 0.73 mA |
| Total energy | W = 210.70 μW |

### Example 4

H. Cucumber—treatment in normal blast chiller
I. Cucumber—treatment in optimized blast chiller

The following tables relate to tests carried out on samples of juice obtained from cucumbers taken from the same lot, kept in the treatment chamber 3 of a normal blast chiller 1 and of one optimized with the device 10, respectively, for approximately 12 hours at a temperature of 24° C. Only after the treatment the cucumbers were sliced, squeezed and immediately analyzed, to avoid the onset of sample oxidation processes.

TABLE 4.H
(Cucumber-treatment in normal blast chiller)
GATHERED DATA

| Substance: | Cucumber-normal blast chiller | | | |
|---|---|---|---|---|
| Date of Analysis: | 22 Sep. 2020 | | | |
| Time of Analysis: | 11:46 | | | |
| | pH | rH₂ | R | Temp. (° C.) |
| Cucumer-normal blast chiller | 6.001 | 24.88 | 228 | 37 |

ANALYSIS RESULTS

| | |
|---|---|
| Redox Potential | E = 161 mV |
| Intensity | I = 0.70 mA |
| Total energy | W = 113.23 μW |

TABLE 4.I
(Cucumber-treatment in optimized blast chiller)
GATHERED DATA

| Substance: | Cucumber-vitalized blast chiller | | | |
|---|---|---|---|---|
| Date of Analysis: | 22 Sep. 2020 | | | |
| Time of Analysis: | 11:41 | | | |
| | pH | rH₂ | R | Temp. (° C.) |
| Cucumer-vitalized blast chiller | 6.059 | 24.34 | 220 | 38 |

ANALYSIS RESULTS

| | |
|---|---|
| Redox Potential | E = 141 mV |
| Intensity | I = 0.64 mA |
| Total energy | W = 90.88 μW |

### Example 5

J. Tomato—treatment in normal blast chiller
K. Tomato—treatment in optimized blast chiller

The following tables relate to tests carried out on samples of juice obtained from tomatoes taken from the same lot, kept in the treatment chamber 3 of a normal blast chiller 1 and of one optimized with the device 10, respectively, for approximately 12 hours at a temperature of 24° C. Only after the treatment the tomatoes were squeezed and immediately analyzed, to avoid the onset of sample oxidation processes.

TABLE 5.J
(Tomato-treatment in normal blast chiller)

| Substance: | Tomato-normal blast chiller |
|---|---|
| Date of Analysis: | 22 Sep. 2020 |
| Time of Analysis: | 11:53 |

| | pH | rH₂ | R | Temp. (° C.) |
|---|---|---|---|---|
| Tomato-normal blast chiller | 4.569 | 17.97 | 201 | 37 |

ANALYSIS RESULTS

| | |
|---|---|
| Redox Potential | E = 35 mV |
| Intensity | I = 0.17 mA |
| Total energy | W = 6.15 μW |

TABLE 5.K
(Tomato-treatment in normal blast chiller)
GATHERED DATA

| Substance: | Tomato-vitalized blast chiller | | | |
|---|---|---|---|---|
| Date of Analysis: | 22 Sep. 2020 | | | |
| Time of Analysis: | 12:02 | | | |
| | pH | rH₂ | R | Temp. (° C.) |
| Tomato-normal blast chiller | 4.486 | 18.05 | 215 | 37 |

ANALYSIS RESULTS

| | |
|---|---|
| Redox Potential | E = 42 mV |
| Intensity | I = 0.20 mA |
| Total energy | W = 8.36 μW |

### Example 6

L. Carrot—treatment in normal blast chiller
M. Carrot—treatment in optimized blast chiller

The following tables relate to tests carried out on samples of juice obtained from carrots taken from the same lot, kept in the treatment chamber 3 of a normal blast chiller 1 and of one optimized with the device 10, respectively, for approximately 12 hours at a temperature of 24° C. Only after the treatment the carrots were sliced, squeezed and immediately analyzed, to avoid the onset of sample oxidation processes.

TABLE 6.L

| (Carrot-treatment in normal blast chiller) | | | | |
|---|---|---|---|---|
| GATHERED DATA | | | | |
| Substance: | Carrot-normal blast chiller | | | |
| Date of Analysis: | 22 Sep. 2020 | | | |
| Time of Analysis: | 12:12 | | | |
| | pH | rH₂ | R | Temp. (° C.) |
| Carrot-normal blast chiller | 6.117 | 24.56 | 149 | 37 |

| ANALYSIS RESULTS | |
|---|---|
| Redox Potential | E = 142 mV |
| Intensity | I = 0.96 mA |
| Total energy | W = 136.12 μW |

TABLE 6.M
(Carrot-treatment in normal blast chiller)
GATHERED DATA

| Substance: | Carrot-vitalized blast chiller | | | |
|---|---|---|---|---|
| Date of Analysis: | 22 Sep. 2020 | | | |
| Time of Analysis: | 12:18 | | | |
| | pH | rH₂ | R | Temp. (° C.) |
| Carrot-vitalized blast chiller | 6.104 | 24.14 | 118 | 37 |

ANALYSIS RESULTS

| | |
|---|---|
| Redox Potential | E = 130 mV |
| Intensity | I = 1.11 mA |
| Total energy | W = 144.31 μW |

### Example 7

N. Blueberry—treatment in normal blast chiller
O. Blueberry—treatment in optimized blast chiller

The following tables relate to tests carried out on samples of juice obtained from blueberries taken from the same lot, kept in the treatment chamber 3 of a normal blast chiller 1 and of one optimized with the device 10, respectively, for approximately 12 hours at a temperature of 24° C. Only after the treatment the blueberries were squeezed and immediately analyzed, to avoid the onset of sample oxidation processes.

TABLE 7.N

| (Blueberry-treatment in normal blast chiller) | | | | |
|---|---|---|---|---|
| GATHERED DATA | | | | |
| Substance: | Blueberry-untreated | | | |
| Date of Analysis: | 22 Sep. 2020 | | | |
| Time of Analysis: | 12:54 | | | |
| | pH | rH₂ | R | Temp. (° C.) |
| Blueberry-untreated | 2.934 | 21.34 | 530 | 37 |

| ANALYSIS RESULTS | |
|---|---|
| Redox Potential | E = 240 mV |
| Intensity | I = 0.45 mA |
| Total energy | W = 108.99 μW |

TABLE 7.O
(Blueberry-treatment in normal blast chiller)
GATHERED DATA

| Substance: | Blueberry-vitalized blast chiller | | | |
|---|---|---|---|---|
| Date of Analysis: | 22 Sep. 2020 | | | |
| Time of Analysis: | 13:00 | | | |
| | pH | rH₂ | R | Temp. (° C.) |
| Blueberry-vitalized blast chiller | 3.027 | 21.17 | 542 | 37 |

ANALYSIS RESULTS

| | |
|---|---|
| Redox Potential | E = 228 mV |
| Intensity | I = 0.42 mA |
| Total energy | W = 95.99 μW |

Based on the assessed chemical-physical parameters (pH level; oxidoreduction potential rH₂ and electrical resistivity R), as summarized above, some indexes were computed by a proprietary software program of the Bioelettronica ATC330 machine, which relate to variables constructed in accordance with techniques known in the art as Vincent's theories.

Such indexes refer to a vital component and an entropic component of the assessed chemical-physical parameters; for further information on this subject, reference should be made to the available literature.

What is important in this context is that the Applicant deems that the results of the tests carried out confirm the presence of a vitalizing effect on foods, which is due to the use of the optimizer device 10 employed in the blast chilling apparatus 1.

As aforesaid, the Applicant believes that, if the device 10 is arranged inside the household blast chiller 1 in such a way that it is crossed by the internal air current produced when the apparatus is in operation, a very weak electrostatic current will be generated therein because of the presence of the different metal layers (copper-silver or any one of the other possible pairs of metal materials mentioned above) that constitute the conical elements 20, and that such weak current, according to experience and tests carried out by the Inventor, can have a positive effect on the foods, improving the preservation thereof, all other conditions being equal, in comparison with a similar apparatus lacking said device.

FIGS. 10(a) to 10(O) show the vital and entropic components of the parameters corresponding, respectively, to those listed in the preceding Tables 1.A, 1.B, 2.C, 2D . . . 7.O. As to vital energy, the following improvements can be observed:

| Measured sample | Vital Energy | Variation % |
|---|---|---|
| A-Grapes-basic conditions | 20.60% | — |
| B-Grapes-after “Normal blast chiller” | 20.50% | — |
| C-Grapes-after “Optimized blast chiller” | 21.04% | +2.63% |

| Measured sample | Vital Energy | Variation % |
|---|---|---|
| D-Apple-after “Normal blast chiller” | 2.73% | — |
| E-Apple-after “Optimized blast chiller” | 4.56% | +67.03% |

| Measured sample | Vital Energy | Variation % |
|---|---|---|
| F-Plum-after “Normal blast chiller” | 7.69% | — |
| G-Plum-after “Optimized blast chiller” | 7.91% | +2.86% |

| Measured sample | Vital Energy | Variation % |
|---|---|---|
| H-Cucumber-after “Normal blast chiller” | 40.30% | — |
| I-Cucumber-after “Optimized blast chiller” | 47.98% | +19.06% |

| Measured sample | Vital Energy | Variation % |
|---|---|---|
| J-Tomato-after “Normal blast chiller” | 89.91% | — |
| K-Tomato-after “Optimized blast chiller” | 87.72% | −2.44% |

| Measured sample | Vital Energy | Variation % |
|---|---|---|
| L-Carrot-after “Normal blast chiller” | 47.50% | — |
| M-Carrot-after “Optimized blast chiller” | 52.19% | +9.87% |

| Measured sample | Vital Energy | Variation % |
|---|---|---|
| N-Blueberry-after “Normal blast chiller” | 15.12% | — |
| O-Blueberry-after “Optimized blast chiller” | 17.69% | +16.38% |

The vital energy of the various foods shows, in general, increasing values from the treatment in the normal blast chiller 1 to that in the blast chiller equipped with the optimizer device 10 according to the invention.

Such value increases range, in percentage, from slightly more than 2% (grapes and plum) to about 67% (apple), with tomato being the only exception (−2.44%).

This has a favourable effect on food preservation, as the Applicant was able to verify by executing a qualitative test in the Applicant's test laboratory on two samples (a), (b) of apricots taken from the same lot and having similar external quality, as shown in the photographic reproductions of FIGS. 11 and 12.

At the beginning, all apricots had a “nice and sound” appearance and were placed into two Fresco apparatuses 1, as previously described, at room temperature.

The first apparatus 1 lacked the optimizer device 10 (lot 1), whereas the second apparatus 1 was equipped with the device 10, placed inside of it (lot 2).

Positioning occurred on Jul. 16, 2020, and the temperature used for the stimulating experimental test was 25° C., continuously 24 hours a day; this was done in order to re-create in the treatment chamber 3 favourable conditions for the proliferation of fruit mildews and microorganisms.

As can be seen in the photographic images 11 (a), (b) and 12 (a), (b), respectively showing lot 1 and lot 2 before, during and after the treatment, with a 6-day residence time (until Jul. 22, 2020), in the apparatus 1 equipped with the optimizer device 10 the fruits (apricots) of lot 2 did not show clear signs of damage.

On the contrary, some fruits of lot 1 showed clear signs of mildews, fungi and onset of marcescence; the Applicant believes that such deteriorated condition of the fruits should be attributed to the absence of the optimizer device 10, which was used in the blast chiller 1 employed for treating the second lot.

From the above experience, the Applicant has inferred that the optimization technique and the use of the associated device 10 are also applicable to apparatus other than the above-considered blast chiller 1, and not only to the foods (fruit and vegetables) of the preceding examples.

For example, for treating water only it is possible to use a specially designed apparatus 100 like the one shown in FIGS. 13 and 14.

The first one of such Figures shows a water dispenser 100 for household or office use, wherein a jug 101 (or a glass, a bottle, or the like) is filled with filtered water.

The dispenser 100 comprises a cavity 102 where the jug 101 is laid in such a position that it can be filled with water from above through an overhead nozzle 103; the water supply command is issued by the user by means of one or more push-buttons 104, preferably located at the front of the dispenser 100.

Within the dispenser 100, as schematically shown in FIG. 13, in which the interior is visible because a side wall has been partially removed, an optimizer device 110 specific for water treatment has been installed.

The device 110 comprises a closed container 111, preferably cylindrical, though it may have another shape (e.g. parallelepiped or the like), in which there is a volume or chamber 113 filled with still water optimized by the device 10. The water optimized by the device 10 transfers its positive effect to a tube immersed in the chamber 113, which in turn transfers it to the water flowing therein through at least one pair of ducts or connectors 114, 115 for letting the water in and out, respectively, as indicated by the arrows in FIG. 13, 14.

Between the inlet 114 and outlet 115 connectors, the path 116 of the water through the container 111 extends along a duct 116, preferably made of metal compatible with water for household or alimentary use, such as copper or alloys thereof, or stainless steel.

The container 111 is preferably made of a metal selected from those compatible with water for household or alimentary use (e.g. metals for taps and fittings, such as brass, bronze, steel); among these, stainless steel proved to be the best.

Nevertheless, other materials may be used as well, not only metallic ones, such as glass, ceramic, plastic, or combinations thereof such as, for example, metal coated with plastic, etc.

Regardless of this, an “Opti-System” optimizer device 10, as previously described, is arranged at the top of the chamber 113, in contact with the container 110 and lapped by the water.

The cone 20 must be arranged inside the box 11 as previously explained.

To this end, the container 110 comprises a body 117 sealingly closed at the top by a lid 118, whereon the “Opti-System” optimizer device 10 lies.

The connectors 114 and 115 are located on the lid 118, and the optimizer device 10 can advantageously be arranged in between.

It must however be pointed out that the optimizer device 10 may also be arranged on the bottom of the container 110.

The water dispenser 100 can be connected to the water mains, e.g. to a tap or downstream of a household water filtering system, so that the water supplied into the chamber 113 through the inlet connector 114 will be optimized.

The circulating water laps the optimizer device 10, thus leading to the favourable effects previously described with reference to the samples treated in the blast chiller 1, and then flows out of the optimizer device 110 through the outlet connector 115.

The performance of the optimizer device 110 were tested as previously shown with reference to the blast chiller 1.

Some chemical-physical parameters of water samples were gathered, namely: pH (acidity value); rH₂ (oxidoreduction potential); R (electrical resistivity).

The analysis of the chemical-physical parameters was conducted on water samples from the waterworks by using the aforementioned measurement system named Bioelettronica ATC 330.

The parameters were analyzed by using the same method as previously described herein, and by subjecting water samples, instead of food samples, to the opti-system treatment in the optimizer device 110.

Respective tables are shown below which contain the data obtained from the different tests.

Such data were then processed by using a software program associated with the Bioelettronica ATC 330 machine, thereby generating diagrams for functions referred to as “Vital pH”; “Vital redox”; “Vital R”; “Vital energy”; “Entropic energy”; “Energetic index”; “Resonance”, as shown in the annexed figures.

GATHERED DATA

| Substance | Water-Vitalized dispenser | | | |
|---|---|---|---|---|
| Date of Analysis: | 22 Sep. 2020 | | | |
| Time of Analysis: | 12:41 | | | |
| | pH | rH₂ | R | Temp. (° C.) |
| Water-Vitalized dispenser | 7.189 | 25.98 | 1460 | 37 |

ANALYSIS RESULTS

| | |
|---|---|
| Redox Potential | E = 121 mV |
| Intensity | I = 0.08 mA |
| Total energy | W = 10.06 μW |

Based on such readings and on the functions processed by the ATC 330 machine and shown in the annexed diagrams, vital energy increased by approximately 21%.

| Measured sample | Vital Energy | Variation % |
|---|---|---|
| P-Water-after “Normal dispenser” | 46.39% | — |
| Q-Water-after “Optimized dispenser” | 56.47% | +21.73% |

Aa a complement to the above-described experimental chemical-physical analyses, the Applicants also carried out some comparative tests to compare the organoleptic characteristics of food products treated by the apparatus according to the invention with those of untreated products.

In particular, such tests concerned different custard and water samples.

The tests were carried out by an external specialized body named EUROISA—Istituto Europeo di Analisi Sensoriale (Via Venzone 12, Treviso—31100; https://www.uniseflab.it/proposta/euroisa.it), which is a laboratory of the UNIS&F agency providing services for the industry in the provinces of Treviso and Pordenone.

The following will summarize the tests carried out and the criteria on which they were based, since it has been deemed inappropriate to append the whole records in excess of 20 pages issued by the EUROISA laboratory, for each one of the tested products.

### Custard

The first product was a well-known type of cream based on egg yolk, sugar, milk and flour, as used in many confectionery products; as a replacement for flour, other thickeners may be used, such as corn or rice starch.

In this case, the Applicants supplied three custard samples, respectively referred to in the results as:

T1: Reference custard T2: Traditional custard T3: Reference custard (replication)

The test method employed was the “Sensory Storming—Test duo trio” method, and the test sessions took place on Jun. 10 and 24, 2021; they were carried out under the supervision of personnel (Tiziano Casanova and Giulia Zanatta) of the Euroisa laboratory, and consisted of anonymously submitting the custard samples T1, T2, T3 to a group of 10 judges.

The judges were 10 anonymous people, representative of various ages, origins, genders, etc. as listed in the following table, taken from the summary report issued by Euroisa.

TABLE 1
The Judges

| | | | | | Efficacy |
|---|---|---|---|---|---|
| Code | Sex | Age | Profession | Taste title | index |
| AJ | M | 1957 | Consultant | Panel Leader | 6.15 |
| AN | M | 1960 | Officer | Panel Leader | 5.85 |
| AQ | M | 1955 | Manager | Qualified sensory | 6.99 |
| | | | | judge | |
| AR | M | 1961 | Industrial designer | Panel Leader | 7.59 |
| AV | M | 1969 | Confectionery | Panel Leader | 8.03 |
| | | | teacher | | |
| BD | M | 1971 | Clerk | Qualified sensory | 6.80 |
| | | | | judge | |
| BF | F | 1965 | Consultant | Qualified sensory | 7.32 |
| | | | | judge | |
| BX | F | 1968 | Food technologist | Panel Leader | 6.30 |
| CD | M | 1967 | Officer | Qualified sensory | 7.06 |
| | | | | judge | |
| DY | M | 1961 | Food expert | Panel Leader | 7.71 |

Each judge was submitted all sample types T1, T2, T3 and wrote his/her evaluations on a paper form for, respectively, the calibration test, the sample test and the replication test.

The analysis was conducted at the Euroisa sensory laboratory without providing the Judges with any information, who then evaluated the samples (by tasting them and then expressing their vote on the paper form) on paper forms; between tastings, they had to rinse their mouth with water.

Calibration was conducted on the sample T1 “Reference custard” with the participation of all Judges, and its efficacy was in turn verified by means of reference parameters.

In other words, in order to limit the risk of dispersion and unevenness in the judgements made by physical persons, the Judges were in turn classified according to five predefined indexes:
i) Repeatability index: measures the Judge's ability to evaluate one sample in two different instants, assigning similar values to each descriptor;
ii) Collimation index: measures the Judge's ability to attribute, for each descriptor and each sample, values that are similar to the group's average values, synthetically expressed by the median;
iii) Discrimination index: measures the Judge's ability to use all the values of the scale, thus being unaffected by psychological constraints that are expressed as tendencies towards minimalism, maximalism or timidity;
iv) Panel Discrimination index: measures the Judges' ability to use all the available scales by comparing his/her behaviour with that of the whole panel;
v) Sample Discrimination index: measures the Judges' discriminating ability, i.e. his/her ability to find differences between samples for each descriptor.

Given such five indexes, it is possible to express a sixth index, called Efficacy index, which represents a synthesis of the other five indexes, suitably weighted, as in the following Table 2.

TABLE 2

| Index | Weight | Threshold value |
|---|---|---|
| Repeatability | 40% | 5 |
| Collimation | 25% | 5 |
| Historical discrimination | 10% | 5 |
| Panel Discrimination | 10% | 5 |
| Sample discrimination | 15% | 5 |

In the case under examination, the Judges' efficacy table for the custard tests was the following:

TABLE 3
Judge' efficacy table

| JUDGE | REPEATABILITY | COLLIMATION | SAMPLE_DISCR | HISTORICAL_DISCR | PANEL_DISCR | EFFFICACY |
|---|---|---|---|---|---|---|
| AJ | 6.27 | 7.33 | 6.07 | 4.00 | 5.00 | 6.15 |
| AN | 8.45 | 4.14 | 3.57 | 3.00 | 6.00 | 5.85 |
| AO | 7.26 | 6.65 | 7.50 | 5.00 | 8.00 | 6.99 |
| AR | 9.64 | 7.36 | 4.64 | 7.00 | 5.00 | 7.59 |
| AV | 9.72 | 9.31 | 1.43 | 8.00 | 8.00 | 8.03 |
| BD | 7.34 | 5.80 | 6.07 | 7.00 | 8.00 | 6.80 |
| BF | 7.30 | 7.14 | 6.79 | 9.00 | 7.00 | 7.32 |
| BX | 7.90 | 3.52 | 5.71 | 7.00 | 7.00 | 6.30 |
| CD | 6.79 | 5.24 | 8.21 | 9.00 | 9.00 | 7.06 |
| DY | 8.61 | 8.74 | 3.21 | 8.00 | 8.00 | 7.71 |

The same group of Judges preliminarily identified the relevant parameters of the product (i.e. custard) for the next evaluation: 33 perceptors/descriptors were identified, divided into five categories as follows: visual perceptors, olfactory perceptors, tactile perceptors, gustatory perceptors and hedonic or evocative perceptors. The perceptors taken into account are listed in the following Table 4.

TABLE 4

| VISUAL PHASE | TACTILE PHASE |
|---|---|
| Yellow color intensity | Creaminess |
| Color homogeneity | Granulosity |
| Glossiness | Consistency |
| Presence of bubbles | Adhesion to palate |
| Presence of black dots | |
| Density/compactness | |
| OLFACTORY PHASE | GUSTATORY PHASE |
| Olfactory intensity | Taste intensity |
| Pleasant/natural smells | Oiliness |
| Bad smells | Sweetness |
| Sweetish smells | Sapidity |
| Lemon fragrance/scent | Fragrance intensity |
| Flower smell | Vanilla flavour |
| Vanille smell | Bad taste |
| Cooked smell | Raw taste |
| Egg smell | Cooked taste |
| EVOCATIVE | |
| Home-made | |
| Farmer product | |
| Genuineness | |
| Harmony | |
| Confectionery | |

The visual, olfactory, tactile and gustatory perceptors contribute to the identification of the statistical medians of the test evaluations for each descriptor and for each sample; therefore, in accordance with known statistical principles, the median Me is the value/mode for which the cumulative relative frequency equals (or exceeds) 0.5, i.e. the second quartile, that is, the 500 percentile.

In the tests conducted by Euroisa, the identification of the median was based on the assumption that the reliability of the results increases with the Judges' univocity in attributing a certain value.

In this case, the median reliability index is expressed on a scale from 0 to 10, where 0 is the minimum and 10 is the maximum. By convention, also supported by an analysis of the test history, the sufficiency value is 6.

Therefore, a higher score indicates that the judgements expressed by the Judges are more concordant around a respective median (high median reliability).

The median reliability indexes for the visual, olfactory, tactile and gustatory perceptors are shown in the following Table 5.

TABLE 5

| SAMPLE | T1 | T2 | T3 |
|---|---|---|---|
| Yellow color intensity | 8.25 | 9.00 | 7.25 |
| Color Homogeneity | 8.42 | 9.21 | 8.95 |
| Glossiness | 8.00 | 7.25 | 8.25 |
| Presence of bubbles | 7.56 | 7.07 | 7.00 |
| Presence of black dots | 7.62 | 8.81 | 6.75 |
| Density/Compactness | 8.00 | 8.00 | 7.38 |
| Olfactory intensity | 6.90 | 8.57 | 7.21 |
| Pleasant/natural smells | 7.56 | 8.44 | 8.18 |
| Bad smells | 8.68 | 8.25 | 8.68 |
| Sweetish smells | 7.95 | 6.74 | 6.44 |
| Lemon fragrance/scent | 7.62 | 8.10 | 7.86 |
| Flower smell | 9.09 | 7.21 | 8.18 |
| Vanilla smell | 9.09 | 7.50 | 7.73 |
| Cooked smell | 7.38 | 6.28 | 7.38 |
| Egg smell | 8.05 | 7.14 | 7.75 |
| Creaminess | 7.75 | 9.25 | 7.75 |
| Granulosity | 8.72 | 8.42 | 8.21 |
| Consistency | 8.18 | 6.19 | 7.95 |
| Adhesion to palate | 7.62 | 7.14 | 8.75 |
| Taste intensity | 7.75 | 7.38 | 6.25 |
| Oiliness | 7.62 | 7.38 | 8.18 |
| Sweetness | 7.86 | 7.62 | 6.59 |
| Sapidity | 7.91 | 7.21 | 7.05 |
| Fragrance intensity | 8.10 | 7.62 | 7.00 |
| Vanilla Flavour | 8.41 | 7.73 | 5.58 |
| Bad taste | 8.46 | 6.92 | 7.95 |
| Raw taste | 9.00 | 8.00 | 8.25 |
| Cooked taste | 6.43 | 6.51 | 6.83 |

As can be seen, within a frame where all parameters are beyond the sufficiency threshold, the least significant perceptor for the custard samples T1 and T3, i.e. the custard samples subjected to the optimization treatment, and for the traditional custard sample T2 is the “cooked taste”.

The most reliable parameters range, in this order, from color homogeneity to raw taste, with glossiness, bad smells, flower smell, vanilla smell, etc. in between.

As is known, it is an established practice in descriptive tests to evaluate the intensity of the individual descriptors, which is obtained by means of an index of (generally median) synthesis of the values expressed by the judges. It is very important to consider also the weight that the different descriptors have in providing the perception map. A more complete profile is thus obtained, created not only from intensity, but also from the frequency of perception of an attribute. This technique is fundamental when judges express their perceptions freely without being constrained by predetermined descriptors, but it is a sign of good information in classical descriptive tests as well.

The purpose of the indexes in this section is to determine, for the various descriptors identified, their relative and absolute “weight” in order to:
i. identify a profile bound not only to intensity, but also to detection frequency;
ii. permit consolidating very specific and mutually correlated descriptors into a smaller number of (more generic) descriptors.

The judges autonomously identified, without influencing one another, the sensory characteristics of the products under examination by assigning values on a scale from 1 (minimum perception) to 10 (maximum perception) to the perceived descriptors.

The data were processed through the use of the geometric mean, taking into account both detection frequency (number of judges who participated for the different samples) and intensity (evaluation on a scale of 1-10), resulting in the attribution of a weight to each identified descriptor.

In the case under examination, the results of the semantic descriptive profile of the various perceptors were as listed in the following Table 6.

TABLE 6

| DESCRIPTORS | T1 | T2 | T3 |
|---|---|---|---|
| Yellow color intensity | 7.77 | 8.05 | 7.77 |
| Color Homogeneity | 8.38 | 8.43 | 8.38 |
| Glossiness | 7.71 | 7.03 | 7.88 |
| Presence of bubbles | 5.02 | 5.02 | 5.02 |
| Presence of black dots | 5.37 | 5.11 | 4.74 |
| Density/Compactness | 7.82 | 7.82 | 7.29 |
| Olfactory intensity | 7.04 | 7.22 | 6.84 |
| Pleasant/natural smells | 6.64 | 6.50 | 6.84 |
| Bad smells | 3.67 | 4.14 | 3.67 |
| Sweetish smells | 6.36 | 6.71 | 6.29 |
| Lemon fragrance/scent | 5.53 | 5.02 | 5.28 |
| Flower smell | 6.00 | 5.37 | 5.69 |
| Vanilla smell | 6.15 | 5.92 | 5.55 |
| Cooked smell | 5.28 | 6.29 | 4.68 |
| Egg smell | 4.65 | 5.02 | 4.74 |
| Creaminess | 7.99 | 8.11 | 7.99 |
| Granulosity | 3.67 | 3.79 | 3.91 |
| Consistency | 6.97 | 6.49 | 6.77 |
| Adhesion to palate | 5.20 | 4.76 | 4.55 |
| Taste intensity | 7.53 | 7.53 | 7.65 |
| Oiliness | 5.37 | 5.92 | 5.85 |
| Sweetness | 7.41 | 7.47 | 7.59 |
| Sapidity | 6.77 | 6.97 | 6.77 |
| Fragrance intensity | 7.35 | 7.22 | 7.71 |
| Vanilla Flavour | 6.77 | 6.84 | 6.43 |
| Bad taste | 3.79 | 4.45 | 4.02 |
| Raw taste | 4.24 | 4.45 | 4.55 |
| Cooked taste | 5.28 | 5.45 | 4.93 |

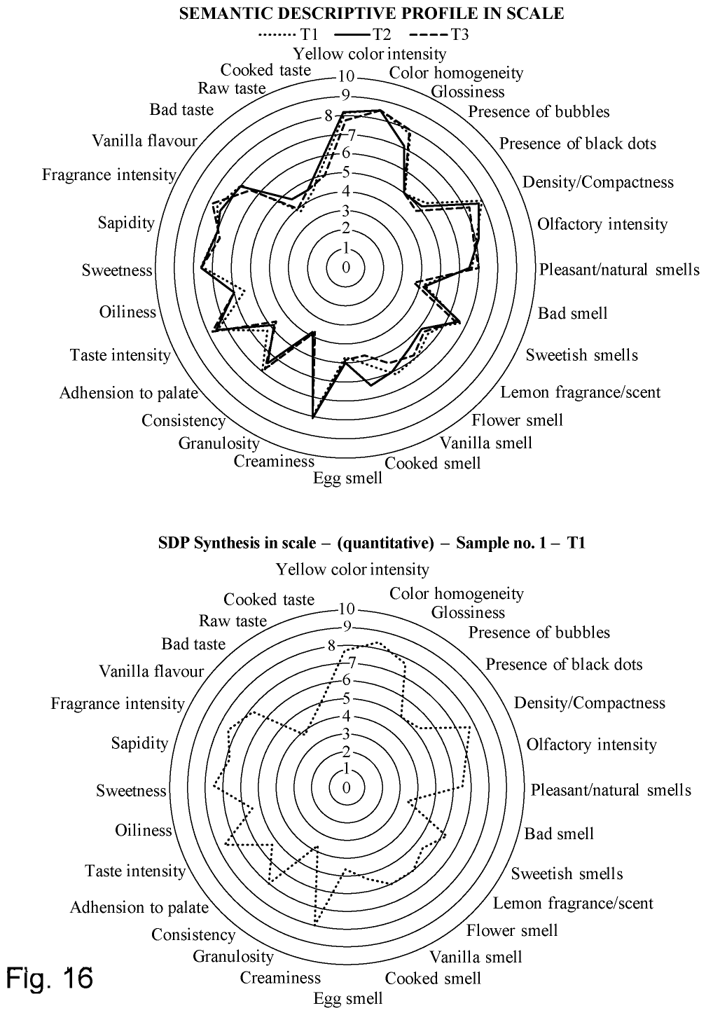

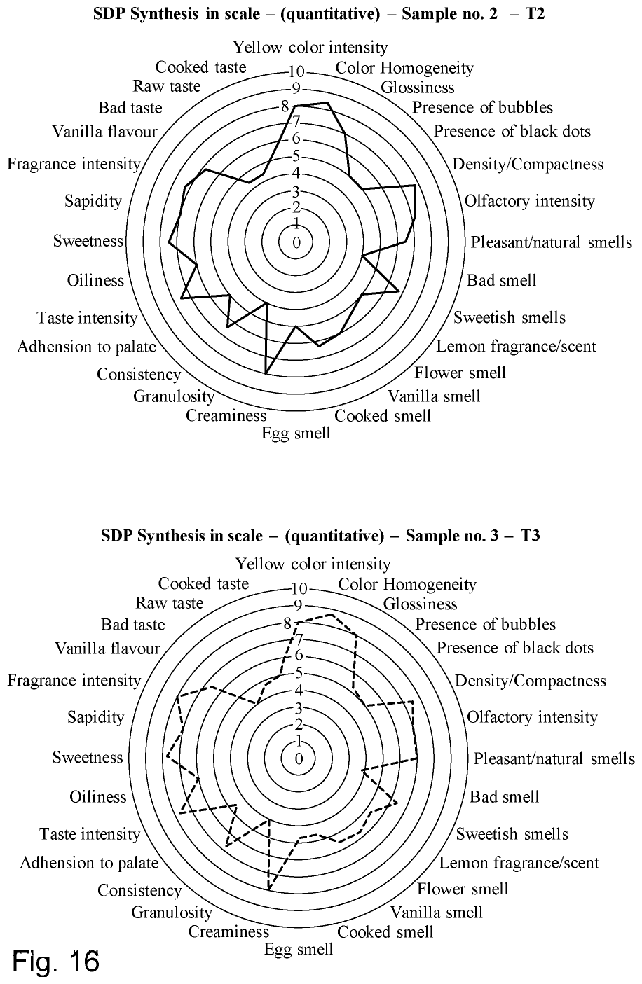

In order to make their appreciation easier and more intuitive, these values have also been processed graphically in FIG. 16, which shows, in polar coordinates, the detections made for the different samples T1, T2 and T3, separately and together (top left graph).

The differences between the reference sample and the traditional product are reasonably small, since it is the same starting product. However, the graph shows that the treatment applied to the sample T1/T3 emphasized some perception elements.

Based on these detections, it is possible to graphically arrange the biggest differences (delta) between the reference products T1 and T3 (i.e. custard subjected to optimization treatment) and traditional custard T2.

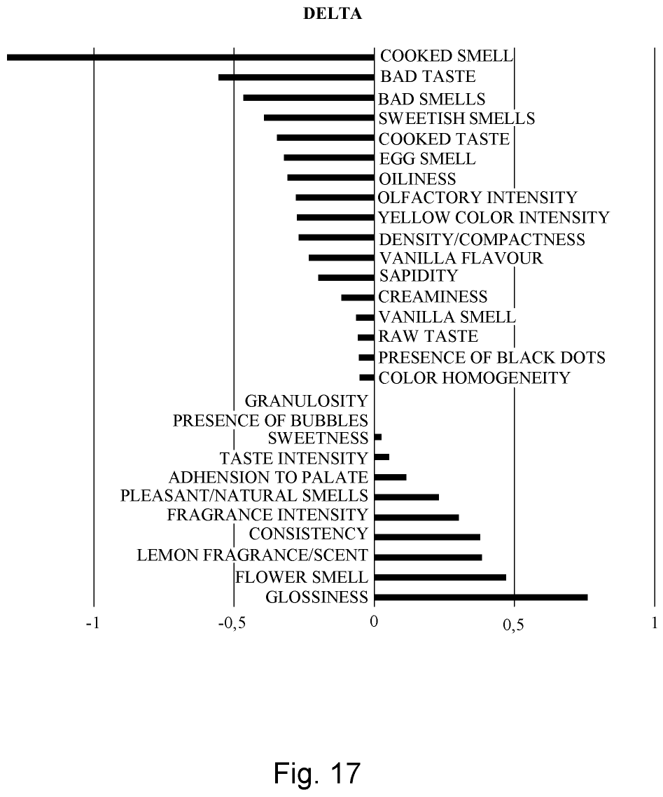

Such differences have been processed graphically into the bar graph of FIG. 17; as can be seen, the DELTA graph shows the difference between the products T1/T3 “reference custard” and T2 “traditional custard”.

The graph highlights that the perception of “cooked smell” is clearly greater for traditional custard. Likewise, the reference sample stands out because of a greater perception of flavours and fragrances and, particularly, higher “glossiness”.

In descriptive tests like those that were conducted on custard samples, it often happens that similar profiles are obtained when the samples are actually different. From a practical viewpoint, action can be taken by re-formulating the form and improving the panel's survey capability, but it is essential to be aware of those descriptors which contribute most to sample characterization.

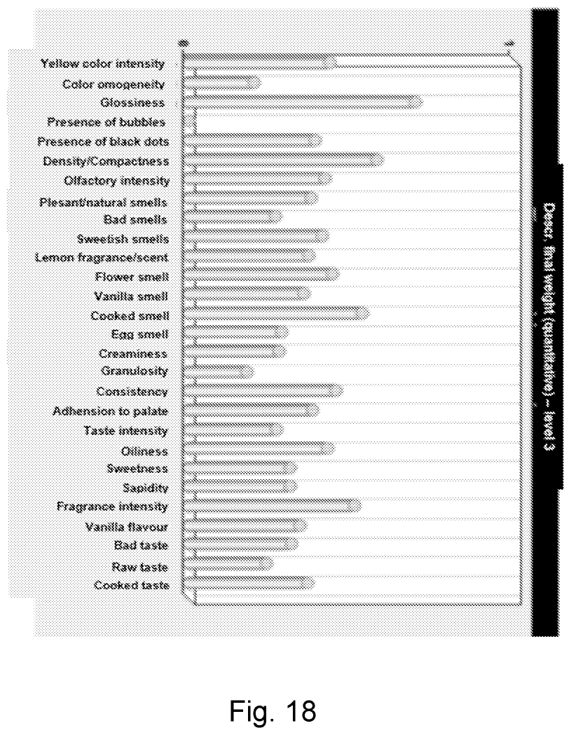

The graph of FIG. 18 shows the weight attributed to each descriptor on a scale from 0 (minimum) to 1 (maximum).

In order to evaluate the general weight of each descriptor, regardless of the result of the individual samples, particular indexes are used, which are then summarized into an overall index that makes it possible to discern the most significant descriptors (higher weight) from less significant ones (lower weight).

The attribution of a weight to the various descriptors is essentially based on frequency and intensity, just as was the case for the individual samples, but here two further weight increasing elements are taken into account:
i. a first element comes from a comparison between the reference sample and its replication; in substance, the more often a descriptor has been recognized in both the reference sample and its replication, the higher the weight attributed thereto;
ii. a second element comes from the descriptor's discriminating capability; the more a descriptor has been useful for highlighting differences between the samples, the higher the weight attributed thereto.

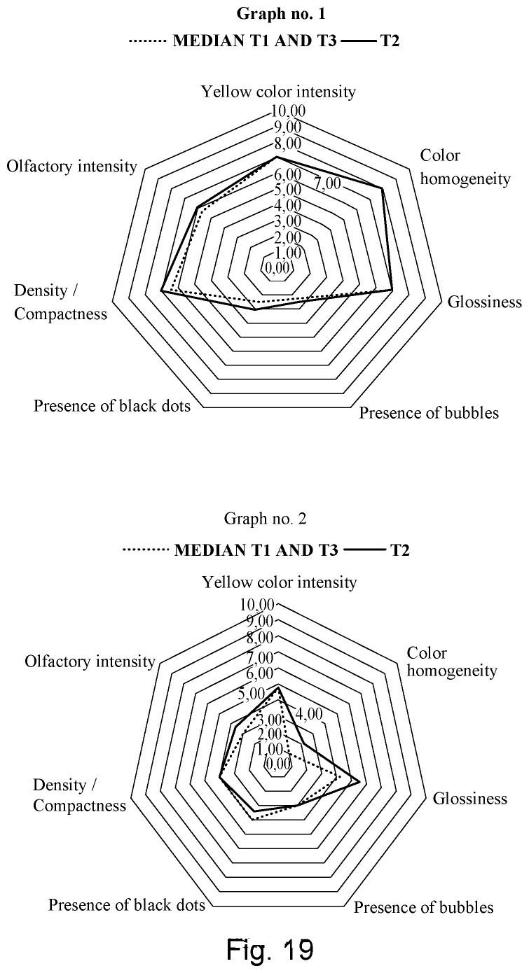

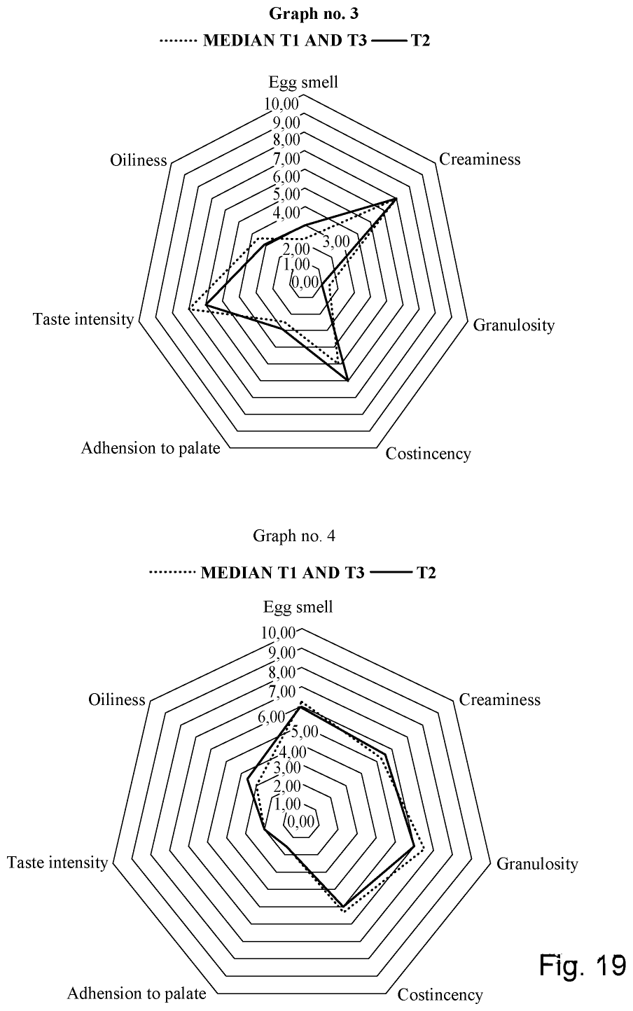

FIG. 19 shows graphs representing the quantitative descriptive profile obtained from the median of the values expressed by the Judges for each descriptor parameter, on a scale from 1 to 10, where the value 1 represents a non-perceived quality (to be understood as descriptive variable), whereas the value 10 represents the maximum intensity.

The graphs of FIG. 19 refer to the medians of the perceptor parameters of the four primary categories: visual (graph 1), olfactory (graph 2), tactile (graph 3), gustatory (graph 4).

The graphs show the median-based quantitative descriptive profile, comparing the synthetic median of the two reference custard samples T1 and T3 with the median of traditional custard T2, and making it possible to assess the importance of the individual descriptors in the overall perception of the products.

In this case, for example, “Density/Compactness”, “Bad smells”, “Sweetish smells”, “Cooked smell”, “Taste intensity” and “Flavour intensity” turn out to be important as distinctive characteristics of the products under examination.

By sorting the survey data in matrix form as in the following Table 7, it is possible to get an estimate of the independence of the data, so as to avoid obtaining biased information or anyway to estimate a possible correlation among the parameters taken into account.

The table of correlations among variables in the evaluated samples shows in green some strong positive correlations. Non-correlation (independence), where the Bravais-Pearson linear correlation coefficient is close to zero, is shown in white in the table, while inverse linear correlation is shown in red.

The analysis of the correlation index permits considering the identified perceptors as optimal for analyzing the products under examination.

In the case under examination, for example, the correlations between “Sapidity” and “Sweetness” (0.82) on one hand and between “Flavour intensity” and “Taste intensity” (0.76) on the other hand stand out.

Lastly, without dwelling any further on the description of this custard example, it should just be added that through a process similar to the one described above it is possible to detect hedonic or evocative perceptor parameters, i.e. descriptors representative of product appreciation.

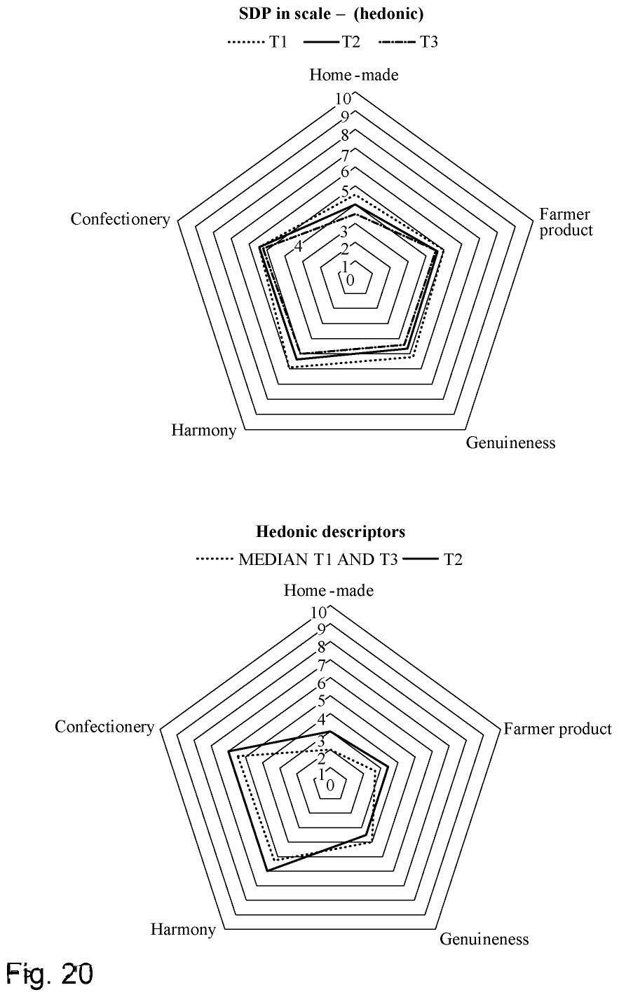

FIG. 20 shows graphs concerning the semantic descriptive profile (SDP), obtained from the median of the values expressed by the Judges for each descriptor on a scale from 1 to 10.

The judges autonomously identified, without influencing one another, the hedonic characteristics of the products under examination by assigning values on a scale from 1 (minimum perception) to 10 (maximum perception) to the perceived descriptors. Non-detection of a descriptor, previously perceived in another sample, equals a score of 1.

The data were processed through the use of the geometric mean, which takes into account both detection frequency (number of judges who participated for the different samples) and intensity (evaluation on a scale of 1-10), resulting in the attribution of a weight to each hedonic quality perceived.

Through a correlation analysis between the hedonic index IE and the values attributed to the quantitative descriptors, the mathematical bond between the intensity of the latter and the overall pleasantness of the product was identified, while obtaining useful indications about which characteristics mostly concur in increasing or decreasing the appreciation of the product according to the panel's judgement on this session's samples. The more positive the value (>0.5), the more direct is the relationship between descriptor intensity and product's pleasantness level.

The processed values are listed in the following Table 8.

TABLE 8

| | IE |
|---|---|
| Yellow color intensity | 0.15 |
| Color Homogeneity | 0.08 |
| Glossiness | −0.18 |
| Presence of bubbles | 0.29 |
| Presence of black dots | 0.15 |
| Density/Compactness | 0.19 |
| Olfactory intensity | −0.08 |
| Pleasant/natural smells | 0.21 |
| Bad smells | −0.26 |
| Sweetish smells | 0.39 |
| Lemon fragrance/scent | 0.46 |
| Flower smell | 0.34 |
| Vanilla smell | 0.05 |
| Cooked smell | 0.12 |
| Egg smell | −0.43 |
| Creaminess | 0.08 |
| Granulosity | −0.23 |
| Consistency | −0.17 |
| Adhesion to palate | 0.03 |
| Taste intensity | 0.14 |
| Oiliness | −0.19 |
| Sweetness | 0.01 |
| Sapidity | 0.15 |
| Fragrance intensity | 0.41 |
| Vanilla Flavour | 0.31 |
| Bad taste | −0.05 |
| Raw taste | −0.31 |
| Cooked taste | 0.47 |

### Water

A comparative analysis like the one just described was conducted by the EUROISA Institute of Treviso also on water samples subjected to optimization treatment with an apparatus like the one shown in FIGS. 13 and 14.

Without repeating the implemented methodological criteria, which were the same as those described for the custard samples, to which reference should be made for brevity's sake, it is just necessary to highlight that in this case the judging panel was composed of seven Judges representative of different extractions and origins, including also qualified sensory judges. Their efficacy was evaluated by means of the above-mentioned index (repeatability, historical discrimination, panel discrimination and sample discrimination), as shown in Table 9.

TABLE 9
The Judges

| | | | | | Efficacy |
|---|---|---|---|---|---|
| Code | Sex | Age | Profession | Taste title | index |
| AJ | M | 1957 | Consultant | Panel Leader | 7.19 |
| AQ | M | 1955 | Manager | Qualified sensory judge | 5.83 |
| AR | M | 1961 | Industrial designer | Panel Leader | 7.06 |
| BD | M | 1971 | Clerk | Qualified sensory judge | 5.57 |
| BF | F | 1965 | Consultant | Qualified sensory judge | 7.34 |
| CD | M | 1967 | Officer | Qualified sensory judge | 6.14 |
| DY | M | 1961 | Food expert | Panel Leader | 5.46 |

Each judge had available all of the sample types listed below, served in tasting glasses.

TABLE 10
The samples

| Code | Product | Producer | Type |
|---|---|---|---|
| T1 | WATER | Supplied by customer | REVITALIZED WATER |
| T2 | WATER | Supplied by customer | MICROFILTERED WATER |
| T3 | WATER | Public waterworks water | TAP WATER |
| T4 | WATER | Supplied by customer: | REVITALIZED WATER |
| | | replication of T1 | |

Each judge had at his/her disposal, as individual equipment: natural mineral water, a notepad and a pen, in addition to paper forms for the calibration, for each sample and for the replication. Having to analyze water samples subjected to the optimization treatment by the apparatus of the invention, the specific visual, olfactory, gustatory, tactile and evocative (or hedonic) perceptor or descriptor parameters differed from those of the custard samples; they are listed in the following Table 11.

TABLE 11
VISUAL PHASE
Colorless
Transparency
Presence of bubbles
Presence of impurities
OLFACTORY PHASE
Presence of smells
Bad smells
GUSTATORY PHASE
Sapidity
Bitter taste
Metallic
Earth smell
TACTILE PHASE
Feeling of residual cleanness
EVOCATIVE
Attractiveness
Fineness
Richness
Lightness
Freshness
Refreshing
Heavy
Mouth-puckering
Pleasantness

The median reliability index was estimated as in the following Table 12, wherein it is expressed on a scale from 0 to 10, 0 being the minimum and 10 being the maximum; therefore, the higher this score, the more the panel judges were in agreement around the respective median (high median reliability). A score of 10 indicates maximum median reliability (maximum agreement in the scores assigned by the panel judges), while the sufficiency value is 6.

TABLE 12

| SAMPLE | T1 | T2 | T3 | T4 |
|---|---|---|---|---|
| Earth smell | 9.63 | 9.63 | 8.89 | 9.26 |
| Bitter taste | 9.26 | 8.52 | 8.52 | 7.78 |
| Trasparency | 8.89 | 10.00 | 9.63 | 9.63 |
| Bad smells | 8.89 | 9.26 | 9.26 | 9.26 |
| Presence of smells | 8.15 | 8.89 | 8.52 | 9.63 |
| Metallic | 8.15 | 6.67 | 8.15 | 9.26 |
| Presence of impurities | 7.41 | 6.30 | 8.15 | 6.67 |
| Colorless | 7.04 | 7.41 | 7.41 | 6.67 |
| Presence of bubbles | 5.93 | 4.81 | 10.00 | 6.67 |
| Sapidity | 5.93 | 5.56 | 8.15 | 6.67 |
| Feeling of residual cleanness | 5.56 | 4.44 | 5.56 | 4.44 |

As can be seen, for all the products that were tasted the perceptor called “feeling of residual cleanness” was not detected (which therefore becomes poorly significant); for the product T2, little significance had also the perceptors called “presence of bubbles” and “sapidity”,

Among the eleven perceptors, as many as 10 turn out to be important and significant for the product T1/T3, For the same product, some significance is lost in the comparison of the “transparency” and “colorless” perceptors, The judges also attributed high scores to “presence of smells”, “transparency” and “metallic” hint,

It is an established practice in descriptive tests to evaluate the intensity of the individual descriptors, which is obtained by means of an index of (generally median) synthesis of the values expressed by the judges, It is very important to consider also the weight that the different descriptors have in providing the perception map, A more complete profile is thus obtained, created not only from intensity, but also from the frequency of perception of an attribute, This technique is fundamental when judges express their perceptions freely without being constrained by predetermined descriptors, but it is a sign of good information in classical descriptive tests as well,

The purpose of the indexes in this section is to determine, for the different descriptors identified, their relative and absolute “weight” in order to: identify a profile bound not only to intensity, but also to detection frequency; permit consolidating very specific and mutually correlated descriptors into a smaller number of (more generic) descriptors,

The judges autonomously identified, without influencing one another, the sensory characteristics of the products under examination by assigning values on a scale from 1 (minimum perception) to 10 (maximum perception) to the perceived descriptors,

The data were processed through the use of the geometric mean, taking into account both detection frequency (number of judges who participated for the different samples) and intensity (evaluation on a scale of 1-10), resulting in the attribution of a weight to each identified descriptor. The results thus obtained are shown in Table 13.

TABLE 13
Semantic descriptive profile

| DESCRIPTORS | T1 | T2 | T3 | T4 |
|---|---|---|---|---|
| Colorless | 8.41 | 8.49 | 8.49 | 8.33 |
| Trasparency | 8.78 | 9.00 | 8.93 | 8.93 |
| Presence of bubbles | 5.20 | 5.67 | 3.00 | 5.20 |
| Presence of impurities | 4.24 | 4.68 | 3.93 | 4.54 |
| Presence of smells | 4.39 | 3.76 | 4.54 | 4.39 |
| Bad smells | 3.59 | 3.40 | 3.40 | 3.40 |
| Sapidity | 5.89 | 5.67 | 5.07 | 5.32 |
| Bitter taste | 3.93 | 3.93 | 3.76 | 4.54 |
| Metallic | 4.39 | 4.68 | 4.09 | 3.93 |
| Earth smell | 3.21 | 3.21 | 3.59 | 3.40 |
| Feeling of residual cleanness | 6.80 | 5.84 | 6.80 | 7.08 |

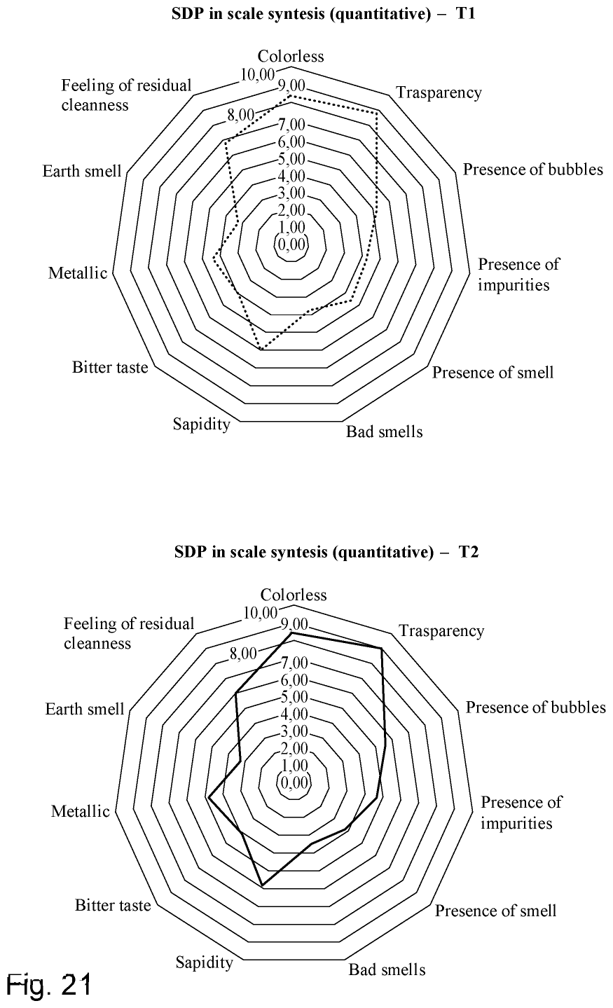

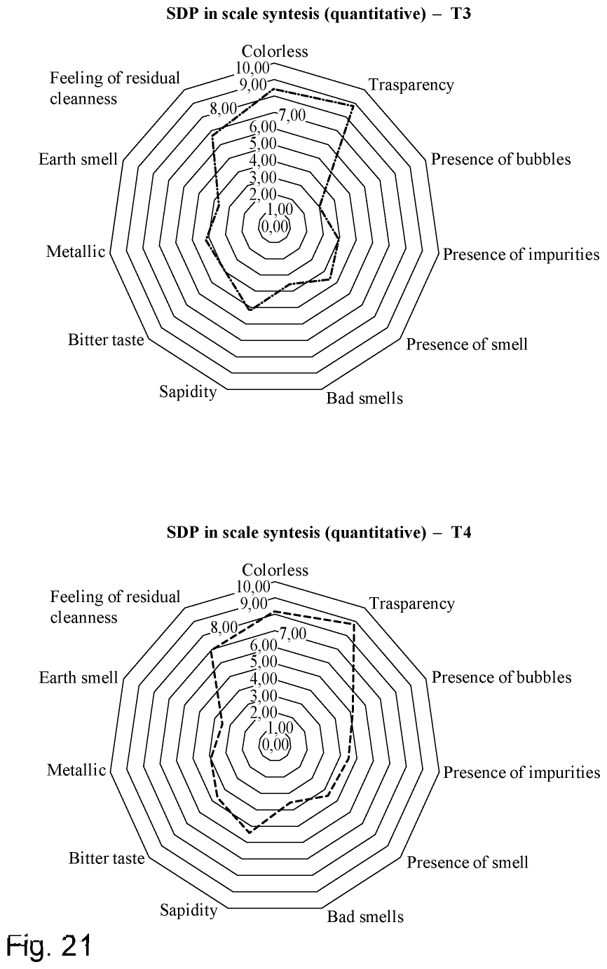

The data pertaining to the semantic descriptive profile (SDP) of the descriptor parameters are shown graphically in FIG. 21,

As can be seen, while having identifiable and peculiar characteristics, the first product sample T1, i.e. water revitalized by the optimization treatment, does not differ much in its sensory analysis from the untreated product T2 (microfiltered water), whereas the product T3 has lower performance, Revitalized water and microfiltered water follow similar lines, with low peaks of discordance, T1 is certainly the one which was perceived as containing fewest impurities and being least metallic, as well as being most sapid and definitely giving one of the highest feelings of residual cleanness,

As far as the presence of perceived smells is concerned, all samples, with the only exception of sample T2 (microfiltered water) are similar. The same similitude trend is observed for the “presence of bubbles” perceptor, except for sample T3 (tap water),

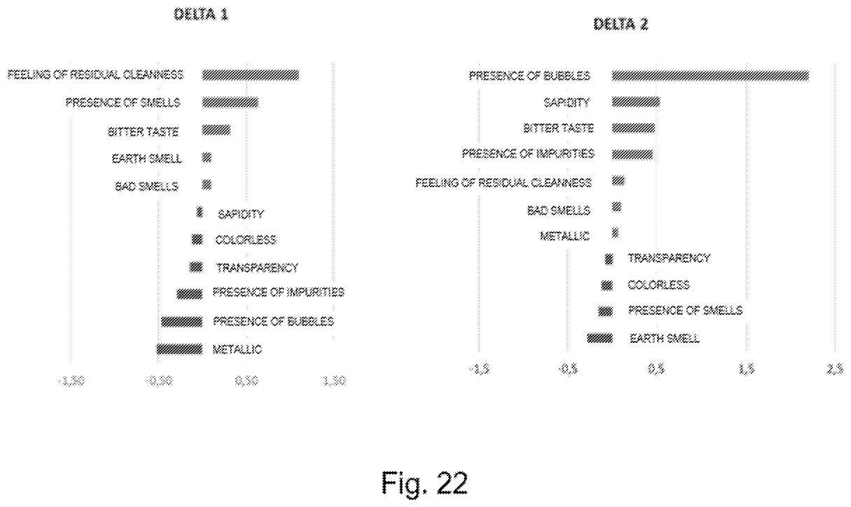

In FIG. 22, the DELTA 1 graph shows the difference between the products T1/T4 “revitalized water” and T2 “microfiltered water”, Revitalized water stands out for a higher feeling of “residual cleanness” and “presence of smells”, whereas no significant difference exists in the perception of bad smells.

At the bottom end of the graph, one can see that revitalized water clearly stands out for a lower perception of a “metallic” hint, The DELTA 2 graph shows the difference between the products T1/T4 “revitalized water” and T3 “tap water”,

Revitalized water definitely stands out for “presence of bubbles” and “sapidity”, while, for example, the different perceptions of “bad smells”, “metallic hint” and “transparency” are not significant,

In this case as well, it is the possible to obtain an evaluation of the existence of a correlation among the gathered data by sorting them in matrix form as shown in the following Table 14.

TABLE 14

| | | | | | | | | | | | Feeling |
|---|---|---|---|---|---|---|---|---|---|---|---|
| | | | Presence | | Presence | | | | | | of |
| | | | of | Presence | of | Bad | | Bitter | | Earth | residual |
| | Colorless | Trasparency | bubbles | impurities | smells | smells | Sapidity | taste | Matallic | smell | cleanness |
| Colorless | 1.00 | | | | | | | | | | |
| Trasparency | −0.05 | 1.00 | | | | | | | | | |
| Presence of bubbles | 0.13 | −0.17 | 1.00 | | | | | | | | |
| Presence of impurities | 0.19 | −0.42 | 0.54 | 1.00 | | | | | | | |
| Presence of smells | 0.10 | −0.61 | −0.19 | 0.41 | 1.00 | | | | | | |
| Bad smells | 0.08 | 0.23 | −0.15 | −0.03 | 0.15 | 1.00 | | | | | |
| Sapidity | 0.24 | −0.19 | 0.33 | 0.14 | 0.10 | 0.11 | 1.00 | | | | |
| Bitter taste | −0.04 | −0.07 | −0.07 | −0.21 | −0.04 | 0.26 | −0.16 | 1.00 | | | |
| Metallic | 0.41 | 0.01 | −0.26 | −0.10 | −0.09 | −0.21 | 0.05 | 0.08 | 1.00 | | |
| Earth smell | 0.22 | 0.19 | −0.02 | −0.19 | 0.07 | −0.03 | −0.18 | 0.32 | −0.02 | 1.00 | |
| Feeling of residual | −0.44 | 0.23 | −0.10 | −0.05 | −0.16 | −0.16 | −0.56 | −0.36 | −0.37 | −0.07 | 1.00 |
| cleanness | | | | | | | | | | | |

For water as well, the hedonic or evocative descriptive profile was then identified, by using the same method as the one employed for custard.

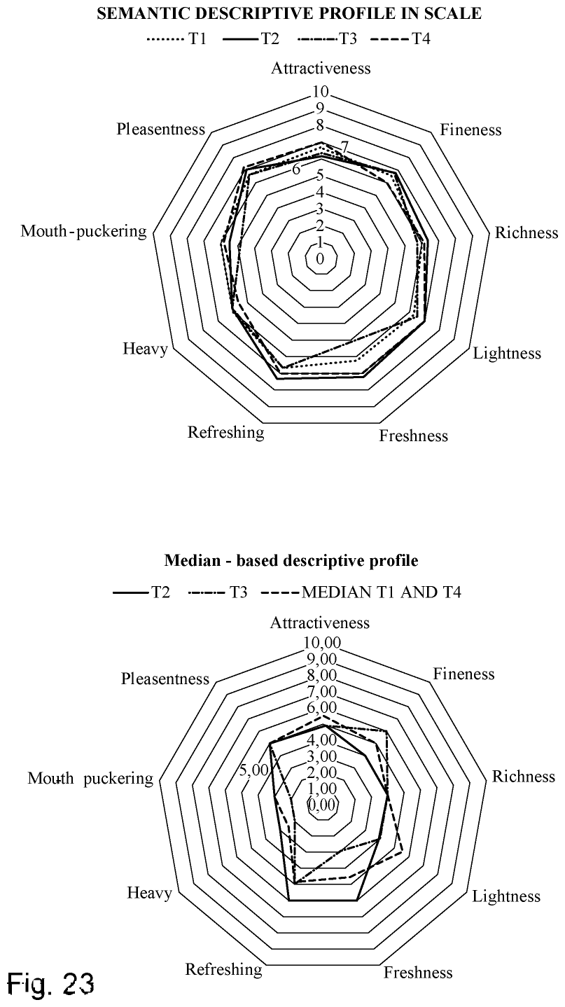

The graph of FIG. 23 shows the semantic descriptive profile and the median-based quantitative profile relating to the hedonic or evocative descriptor parameters.

In the first graph, the purpose of the indexes in this section is to determine, for the different descriptors identified, their relative and absolute “weight” in order to: identify a profile bound not only to intensity, but also to detection frequency; permit consolidating very specific and mutually correlated descriptors into a smaller number of (more generic) descriptors.

The data were processed through the use of the geometric mean, which takes into account both detection frequency (number of judges who participated for the different samples) and intensity (evaluation on a scale of 1-10), resulting in the attribution of a weight to each hedonic quality perceived.

In the second graph, by comparing the synthetic median of the two samples T1 and T4 of revitalized water with the medians of the other two products T2 and T3, it is possible to identify the importance of the individual descriptors within the global perception of the products, For example, in this case “feeling of residual cleanness”, “bitter taste” and “presence of bubbles” turn out to be important for the identification of the distinctive characteristics of the products under examination.

The overlaid graph indicates, among the strong points of the product T1/T4, hedonic elements such as “pleasantness”, “lightness” and “attractiveness”, and a limited perception of heaviness, In comparison with the previous one, product T2 has a lower level of attractiveness, but a higher perception of “freshness” and “refreshing” quality; as regards product T3, a low sense of “freshness” is reported. Through a correlation analysis between the hedonic index and the values attributed to the quantitative descriptors, a mathematical bond between the intensity of the latter and the overall pleasantness of the product is identified, while obtaining useful indications about which characteristics mostly concur in increasing or decreasing the appreciation of the product according to the panel's judgement on this session's samples. The more positive the value (>0.5), the more direct is the relationship between descriptor intensity and product's pleasantness level.

The results of this analysis are summarized in the following Table 15.

TABLE 15

| DESCRIPTORS | IE |
|---|---|
| Trasparency | 0.67 |
| Bad smells | 0.29 |
| Feeling of residual cleanness | 0.23 |
| Sapidity | 0.16 |
| Presence of bubbles | −0.04 |
| Metallic | −0.05 |
| Colorless | −0.10 |
| Bitter taste | −0.14 |
| Presence of impurities | −0.18 |
| Earth smell | 0.26 |
| Presence of smells | −0.52 |

Comparative experimental analyses conducted on different products, such as custard and water, essentially confirmed what had been previously observed through chemical-physical analyses, i.e. that the optimizer device 10, in its various embodiments, affects the organoleptic properties, or at least some of them.

This promotes the preservation of the foods, and also their appreciation, as highlighted by the descriptor parameters taken into account.

In light of the above description, it is possible to specifically set out the features of the invention in the following claims.

1-17. (canceled)

18. An apparatus for treating and/or preserving foods, water, liquids, and the like, comprising:
an external structure in which there is at least one treatment chamber in which said foods, water, liquids, and the like are arranged;
means for circulating a flow of fluid in said chamber, and
an optimizer in which there is at least one active element comprising different layers of materials, adapted to interact with the flow of fluid circulating in the treatment chamber and lapping the foods, water, liquids, and the like arranged in the chamber.

19. The apparatus according to claim 18, wherein the optimizer is housed in the treatment chamber or adjacent thereto.

20. The apparatus according to claim 19, wherein the different layers of materials of the active element comprise metal materials.

21. The apparatus according to claim 20, wherein the different layers of the active element comprise at least one metal from the group consisting of copper, aluminium, and alloys thereof, coated with a precious metal selected from the group consisting of silver, gold, platinum, and alloys thereof.

22. The apparatus according to claim 21, wherein said alloys of the active element comprise brass, bronze, zamac and aluminium bronze.

23. The apparatus according to claim 22, wherein said at least one active element comprises a substantially conical element made of a metal material selected from the group consisting of copper, aluminium, and alloys thereof, coated with a precious metal selected from the group consisting of silver, gold, platinum, and alloys thereof.

24. The apparatus according to claim 23, wherein said at least one active element is housed in a metallic container.

25. The apparatus according to claim 24, wherein the container is made of stainless steel.

26. The apparatus according to claim 25, wherein the container is a blast chiller for foods, operating in a temperature range between 2° C. and 80° C.

27. The apparatus according to claim 25, wherein the container is a water dispenser.

28. The apparatus according to claim 27, further comprising a container in which a chamber is defined, in fluid communication with the outside through at least one inlet and an outlet for supplying water or another liquid, where at least one optimizer device is housed.

29. The apparatus according to claim 25, further comprising a refrigerating unit selected from the group consisting of a refrigerator, a cold storage room, and a food preserving apparatus.

30. A method for treating and/or preserving foods, characterized in that it comprises a step of residence, for a predefined time, in an apparatus according to claim 1.

31. The method according to claim 30, wherein the residence time is comprised between some minutes and some hours.

32. The method according to claim 31, wherein the residence time is less than 180 minutes.

33. The method according to claim 32, wherein the foods comprise at least one from among fruit, vegetables, meat, fish, dairy products, and juices.

34. The method according to claim 32, comprising a step of reducing the temperature to a value between 3 and 10° C.
